(19) United States
(12) Patent Application Publication
(10) Pub. No.: US 2002/0087592 A1
(43) Pub. Date: Jul. 4, 2002

(54) Presentation file conversion system for interactive collaboration

(76) Inventor: Jamal Ghani, Richmond, CA (US)

Correspondence Address: GREGORY SCOTT SMITH, P O BOX 2192, FREMONT, CA, 94536

(21) Appl. No.: 09/944,783

(22) Filed: Aug. 30, 2001

Related U.S. Application Data
(60) Provisional application No. 60/259,327, filed on Dec. 29, 2000.

(51) Int. Cl. G06F 15/00

(52) U.S. Cl. 707/500

(57) ABSTRACT

The present invention provides a system and method for converting application specific presentation file stored with corresponding metadata to a universal format for display on a web browser without downloading of software to the client devices. The method includes the following steps: uploading the application specific file, detecting the uploaded application specific file, reading the metadata, determining from the metadata whether the file extension corresponds to the specific application, loading the file, validating that the file corresponds to the specific application by examining header information, converting the application specific file into a universal image file format, modifying the file, validating the resolution of the file, storing the file for display on the web browser, and transmitting the file to the web browser for display.

### RELATED APPLICATIONS

This application claims the benefit of U.S. Provisional Application No. 60/259,327 filed Dec. 29, 2000. Additionally, this application is related to the following copending applications filed on the same day and assigned to the same entity as the present application, which are incorporated herein by reference: U.S. Ser. No. ______ entitled Graphical User Interface For An Interactive Collaboration System; and U.S. Ser. No. ______ entiled Computer Based Interactive Collaboration System Architecture.

### FIELD OF THE INVENTION

The present invention relates generally to computer based educational and collaboration services. More particularly, the invention relates to a method and apparatus for providing a computer based interactive, collaborative, educational and meeting system, coupled with direct consumer marketing, which allows both the presenter and participant a high level of real time interactivity without downloading or installing any software on either the presenter or participant computer.

### BACKGROUND OF THE INVENTION

Networked educational and meeting services are generally known. However, they are limited by the constraints of the Internet and the vagaries of participant computers. More specifically, current services suffer from a lack of standardization in presentation formats and the requirement that participants have data presentation format specific software (e.g. MS Word, Word Perfect, Excel, etc.) resident on the participant computer. The master teaching or presenter computer dictates the presentation format, which may not be compatible with the presentation software resident on the participant computer, making the Internet learning/teaching experience a cumbersome and impractical alternative to traditional classroom attendance and participation.

The present invention solves these problems by providing improvements in several key areas but namely in presenter-participant interaction by supplying dynamic whiteboard capabilities, real-time full-duplex audio and video capabilities, web touring, session management, polling, file sharing, whisper capabilities, attendance, and hand raising features for participant hand-off capabilities. Along with underlying direct access technology by which presenter and participant can interact without any downloading or installation of software.

### SUMMARY OF THE INVENTION

The present invention provides a computer-based system for facilitating collaborative interactions via the Internet or an intranet. In particular, the present invention provides a presenter/participant interactive computer based educational and meeting system, coupled with the ability for direct consumer marketing. Using multiple computers the system allows a multiplicity of individuals to mimic a live classroom or meeting setting by providing various parallel features such as real time audio and visual capabilities, hand raising features, whispering features, attendance tracking, participant polling, hand-off capabilities, an interactive whiteboard, and a variety of other information and content sharing capabilities, all without downloading any software.

Moreover, the present invention bridges the gap between text-only interactions and live interactive audio streaming. The present invention also includes the ability for the session presenter, as well as the participants, to speak and be heard. The live audio functionality allows the facilitator to talk to the participants as he/she guides them through presentations, training, product demos, or any other type of session. This allows a presenter to present sessions, which mimic or parallel “live” sessions. In addition, participants are able to speak in order to ask questions, make comments, or provide additional information.

In particular, the present invention provides a system and method for converting an application-specific presentation file stored in a first data store with corresponding metadata to a universal format for display on a web browser. The method includes the following steps: uploading the application specific file to the first data store, detecting the uploaded application specific file in the database, reading the metadata corresponding to the application specific file from the database, determining from the metadata whether the file extension corresponds to the specific application, loading the application specific file from the database, validating that the application specific file corresponds to the specific application by examining header information of the application specific file, converting the application specific file into a universal image file format, modifying the resolution of the universal format file, validating the resolution of the universal format file, storing the modified universal format file in a second data store for display on the web browser, and transmitting the modified universal format file to the web browser for display. Principally, the application specific files are Microsoft PowerPoint format files and the universal image file format is a JPEG format.

### BRIEF DESCRIPTION OF THE DRAWINGS

FIGS. 1 through 26 of the drawings depict a version of the current embodiment of the present invention for the purpose of illustration only. One skilled in the art will readily recognize from the following discussion that alternative embodiments of the structures and methods illustrated herein may be employed without departing from the principals of the invention described herein.

FIG. 1 depicts a block diagram of the structural relationship between the presenter and participants in the present invention.

FIG. 2 shows a graphical user interface constituting the presenter window.

FIG. 3 shows a graphical user interface constituting the participant window.

FIGS. 4a-b show graphical user interfaces constituting the whiteboard menu screen for the presenter and participant, respectively.

FIGS. 5a-d show graphical user interfaces for the polling windows of the system.

FIG. 6 shows a graphical user interface constituting a presentation window for movies and other content.

FIG. 7 shows a graphical user interface constituting the attendance window.

FIG. 8 is a block diagram representative of the navigation of the system homepage.

FIG. 9 is a block diagram representative of the navigation through the Join Session portion of the system.

FIGS. 10a-f are block diagrams representative of the navigation through the Options portion of the system.

FIG. 11 is a block diagram representative of the navigation through the Registration portion of the system.

FIG. 12 is a block diagram of the system components, which facilitate the automated presentation conversion process.

FIG. 13 is a flow chart of the automated presentation conversion process in relation to the system components depicted in FIG. 9A.

FIG. 14 is a block diagram of the system architecture of the streaming audio collaboration process.

FIG. 15 is a block diagram further detailing the media streaming tunneling with respect to the overall system architecture.

FIG. 16 shows a block diagram detailing the streaming audio collaboration process of the system.

FIGS. 17a-c show the overall system layout detailing the various client side Java applet and server side servlet interactions.

FIG. 18a is a block diagram depicting portions of the conference applet architecture.

FIG. 18b is a block diagram depicting portions of the queue applet architecture.

FIG. 18c is a block diagram depicting portions of the whiteboard applet architecture.

FIG. 18d is a block diagram depicting portions of the breakout applet architecture.

FIG. 19 is a block diagram depicting portions of the main servlet architecture.

FIG. 20 shows a block diagram detailing multiple user connections in the system.

FIG. 21 shows a block diagram detailing categories of controls provided by the Java servlets, applets and scripts utilized by the system architecture.

FIG. 22 shows a block diagram detailing the system architecture of the white board component.

### DETAILED DESCRIPTION OF THE PREFERRED EMBODIMENT

Overview

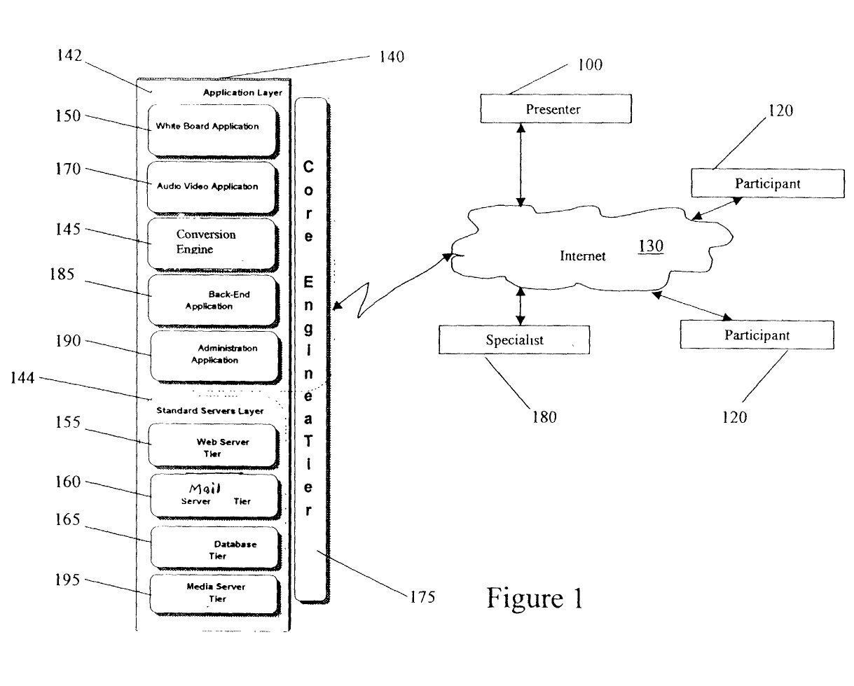

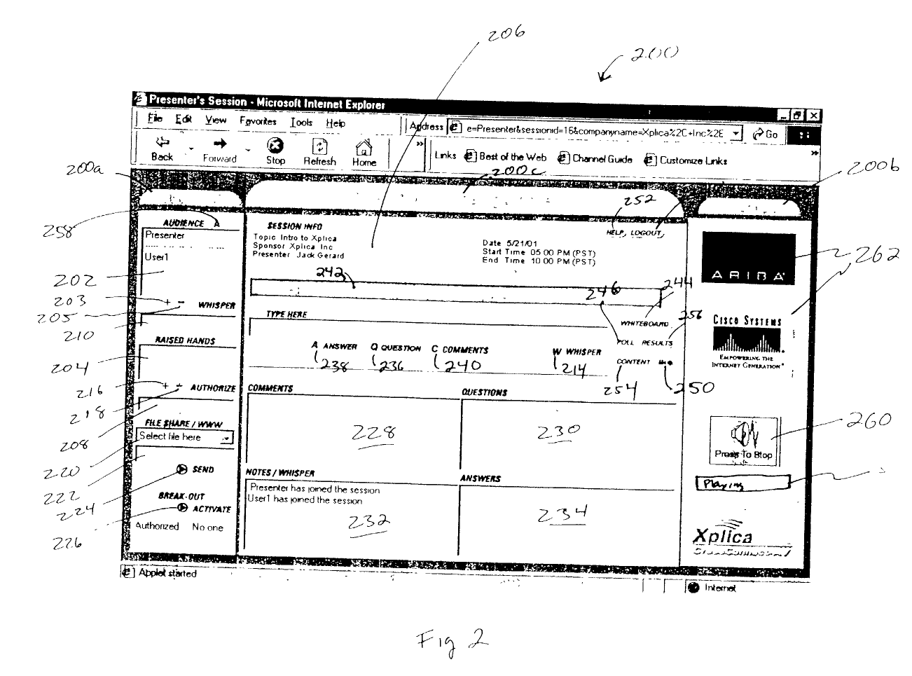

The basic structural relationship between presenter computer 100 and participant computers 120 is depicted in FIG. 1. Presenter computer 100 and participant computers 120 are all linked together by web-based system server 140 via the Internet 130 for facilitating collaboration between a presenter and a plurality of participants. All of the presentation content is uploaded by the presenter to and maintained on server 140. In order to control the collaboration process, all communications between presenter computer 100 and participant computers 120 are passed through and controlled by server 140. There are no direct communications between presenter computer 100 and participant computers 120. While only a single presenter computer 100 relative to multiple participant computers 120 is depicted in FIG. 1 to represent a single collaboration session, server 140 might be coupled to multiple presenter computers 100 since event server 140 can simultaneously process multiple collaboration sessions.

Server 140 is constructed of a variety of different applications including conversion engine 145 (developed in VC++), whiteboard application 150 (developed in Java), core engine 175 (developed in Java), audio/video media engine 170 (developed ATL in VC++), back-end application 185 (developed in JSP), and administrative application 190 (developed in JSP). Additionally, server 140 includes several different standard server technologies: web server 155 (which can be any commercially available web server application that provides web publishing functionality such as Java web server from Sun Microsystems or Apache-Tomcat servers), mail server 160 (which can be any commercially available mail server that provides SMTP mail functionality such as Internet Information Server from Microsoft), database 165 (which can be any specially configured commercial database product such as MS-SQL from Microsoft), and media server 195 (which can be any commercially available media server application that provides audio/video streaming functionality such as Media Streaming Server from Microsoft).

Core engine 175 controls communications and interactions between all of the other applications on server 140 as well as communication with presenter computer 100 and participant computers 120.

The components of application server 140 comprise two layers. System application layer 142 includes system specific, specially programmed applications: whiteboard application 150, media streaming application 170, presentation conversion and publishing engine 145, back-end application 185, administration application 190 and core engine 175. Standard server layer 144 includes commercially available third party server applications provide different type of services as needed: web server 155, mail server 160, database 165, and media server 195. The architecture of server 140 is described below in more detail in the System Architecture section.

The presenter is the person who initiates a session, or event. This is different from the perspective of those merely participating in the collaboration session. The presenter has access to many more functional controls than the participants.

The system allows a presenter to share numerous types of materials during a session with participants. Some of these materials include documents, presentations, spreadsheets, images, movies, and questionnaires. In addition to the different types of materials, the presenter also has several options on how to make the information available to participants. These options include making the material available for download, only for playback, available prior to the session, for interactive participation, available using special streaming technology.

The system also provides for participation by a specialist during a session. A specialist, while not the leader of the collaboration session, acts as a co-presenter when authorized. The system architecture treats specialist computer 180 physically like participant computers 120 as authorization is required for specialist computer 180 to exercise control over the session and logically like presenter computer 100 as specialist computer 180, when authorized, has the same control (except web touring/get file, breakout sessions, poll results, attendance) over the session as presenter computer 100.

Generally, the content can be classified as pre-session content, session content, movies, white board presentations (e.g., PowerPoint slide shows), or special files. Pre-session content is used to prepare participants for the session, promote the session, and encourage people to register and attend. The presenter loads the pre-session materials to server 140 when the session is set up and then can be downloaded before the start of the session by participants. Furthermore, the content is accessible prior to the session when reviewing session logistics and during registration. While the pre-session content can include any type of content, it is not recommended for movies.

The session content includes the same materials as pre-session content and often is used as reference material during the session. The materials are loaded by the presenter when setting up the session and then are available for download. The session content is accessible by the presenter and participants during the session. Furthermore the session content can include any type of content, but is not recommended for movies.

The presenter loads audio/visual content (e.g., movies and audio clips) to server 140 when the session is set up, and audio/visual content is accessible by the presenter and participants during the session. Audio/visual content is used for playing and streaming pre-recorded movies (video files) or audio clips and for streaming large files without any download. The audio/visual content may also include smaller files, which are delivered either via file download or through live streaming. Streamed materials cannot be downloaded or saved by participants.

Participants are able to use live audio streaming in a variety of ways to more easily accommodate the equipment at their disposal. The functionality of the present invention enables voice over internet protocol (VolP) to allow users to speak directly from one computer to another over the Internet. This allows voice communication even if the user has only one phone line. VolP does require, however, that the user have a sound card, microphone and speakers. For users without a microphone and speakers, the system also has enabled audio functionality via telephone. This allows participants to speak through a standard telephone. Audio streaming operates from pc to pc and telephone to pc.

Audio functionality makes user interactions more seamless and easier to use. Full voice capability is pushed out to the users without an application download, operating on 28.8 kbps connections or higher. Furthermore, the system offers this functionality in most cases without prompting the presenter or the participants to download any software from server 140 or any other source.

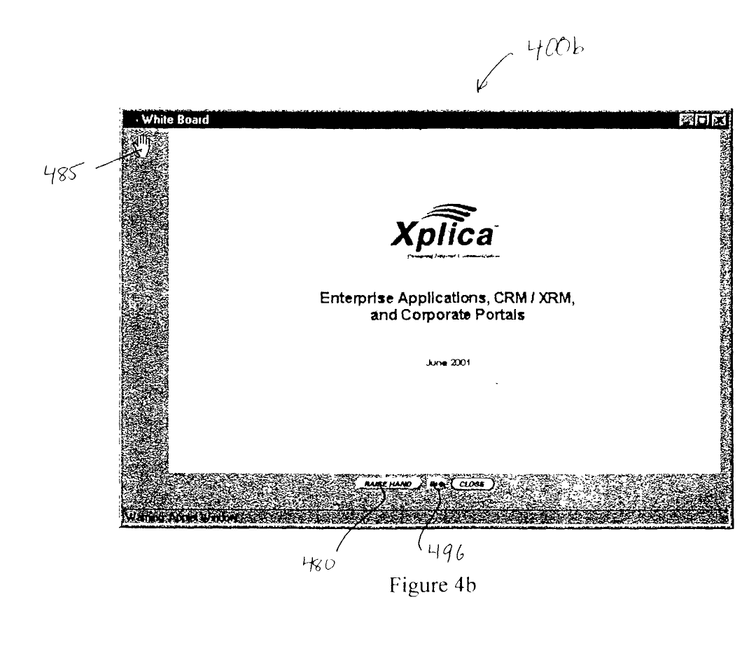

The system also has a dynamic whiteboard platform for information exchange. Whiteboard presentations are used by the presenter to drive presentations directly on participants' screens and allow for interactive presentations with annotations and where control can be given to participants. The participants cannot download these materials from server 140. The presenter loads the presentations to server 140 when the session is set up and controls when participants can view it using whiteboard 400 (see FIG. 4). Additionally, the presenter can authorize specific participants to have access to whiteboard 400 to make annotations. One example of a white board presentation is a Microsoft PowerPoint slide show, which is the preferred presentation type of the present invention.

In the preferred embodiment, presentation conversion and publishing engine 145 utilizes MS PowerPoint format (PPT) files, which are converted into an image format file. Whiteboard application 150 then displays the image format file on whiteboard 400. While presentation conversion and publishing engine 145 converts only PPT files, other types of files maybe displayed on whiteboard 400. In particular, any presentation in a format that can be converted to a PPT file (e.g., MS Word, MS Excel) can be displayed on whiteboard 400 by converting the presentation into a PPT file before the presentation is processed by presentation conversion and publishing engine 145.

Other content may include special files, images, web tours and interactive questionnaires, which are used by the presenter to display content directly on participants' screens. The types of files are useful as backup files for the presenter and can be used as necessary. The presenter loads the special files when setting up the session and controls when participants can view the files. The special files are pushed to participants when played.

The whiteboard platform provides a presenter with a strong set of tools to manage events. Key features of whiteboard application 150 include: presentation running (e.g., navigating backward and forward through whiteboard 400), annotation tools, and the ability to hand-off controls to multiple participants (known as hand raising and authorization).

Presentation running allows the presenter to direct the image that each individual participant sees on his or her respective screens. For instance, a presenter can run a converted PowerPoint slide show on his or her whiteboard 400a, and as the presenter Flips from slide to slide, each participant is able to see the slides progress through his/her own whiteboard 400b. This puts the ability to guide the event in the hands of the presenter.

In addition to running presentations through whiteboard 400, the presenter can also open a web browser and guide participants to various websites, i.e., a web tour. As the presenter directs his or her browsers and clicks through to new pages or sites, all of the participants view the same pages through their own browsers. This functionality can be applied for navigating Internet or intranet sites. A dedicated browser that is downloaded to participant computers 120 provides this web tour feature. The dedicated browser functions much in the same way as whiteboard 400 in that a hand raise button is provided on the participant view and a authorize buttons are provided on the presenter view in order to allow for co-share capability.

To provide additional support while using whiteboard 400, the system features a built in set of annotation tools. The annotation tools enable the presenter to call attention to specific items on the whiteboard by using highlighters, pointers, drawing tools, and the ability to add text comments. The presenter can also undo specific annotations using a select button or erase the whole drawing including the slide by just pressing a clear button. By selecting an annotation tool, such as the highlighter, the presenter can highlight a specific area on his or her whiteboard 400a, and all of the participants will see the highlighting appear through their own whiteboards 400b at the same time. Freehand annotations can be made using a mouse or writing tablet.

The system not only gives a presenter the enhanced ability to guide an event, the presenter can also pass control of whiteboard 400 to individual participants as desired. For instance, if participants have questions, or additional information to share, the presenter can pass the controls to the participant. The participant controlling these features is then able to guide what all of the other participants see through their whiteboard 400b including the ability to run presentations and annotate. Participants can also be granted control to conduct web tours, if so desired by the presenter.

Participants can raise their hands (figuratively) directly from whiteboard 400b to request presenter controls. The presenter can see who has a raised hand and can authorize the participants directly from whiteboard 400a.

The ability to hand off control does have an additional requirement related to running applications. If the presenter wishes to give control to a participant for them to run an application, it is necessary that the participant have the application installed on their participant computer 120. If the participant has the application installed, and the presenter grants him or her access, the participant can guide what is seen on whiteboard 400 and they can also add content, edit files and save updates. This functionality allows multiple participants in different locations to work together on the same files at the same time.

Graphical User Interface

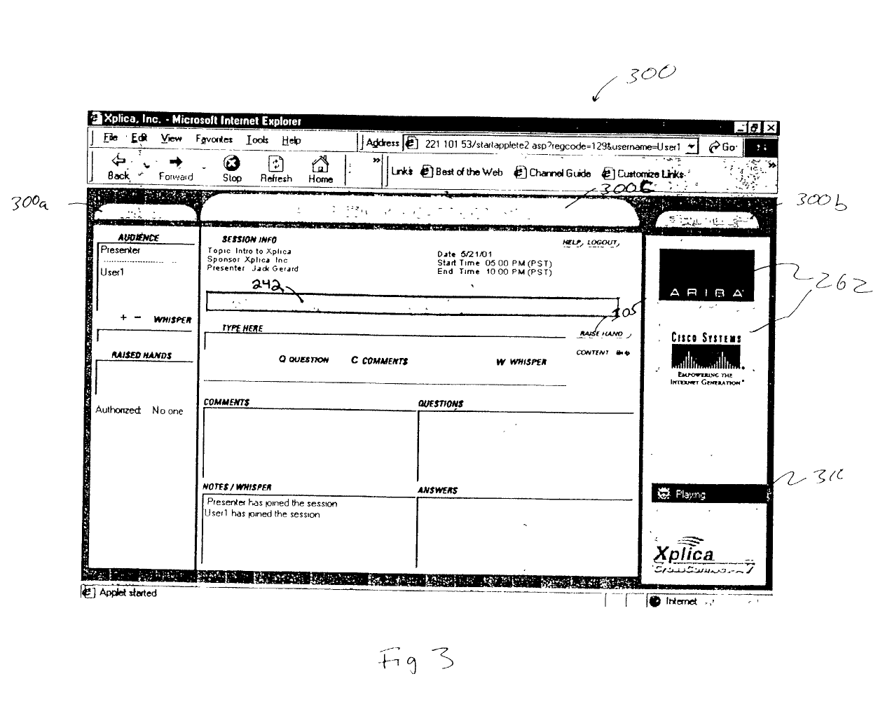

Graphical user interfaces (GUI's) allow the presenter, participants and the session administrator to interact with the system and each other. The key windows of the system GUI's for the presenter and the participants are depicted in FIGS. 2-7.

Referring now to FIG. 2, the system's primary graphical user interface (GUI) for the presenter, presenter window 200, is shown. The presenter is the individual(s) who leads a meeting, instructs, or teaches a program for students or participants. Presenter window 200 is spatially divided into three console areas: control A console 200a, control B console 200b, and master communication console 200c. In general terms, control A console 200a contains controls for selecting and deselecting participants and files sent to those participants. Control B console 200b contains advertisement information and speech (Voice) controls. Master communication console 200c contains controls for the transmission and receipt of collaboration information between the presenter and participants.

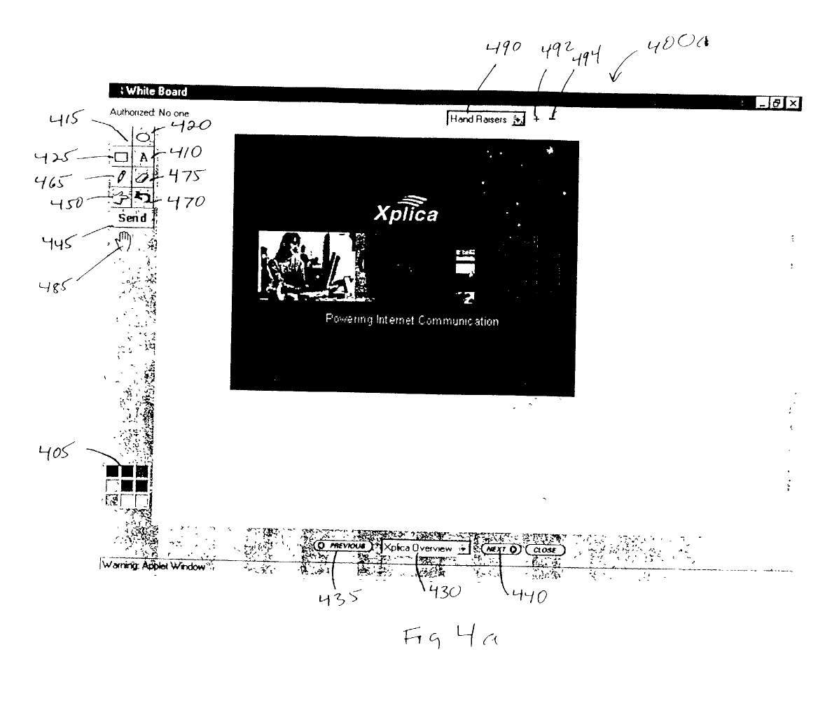

On control A console 200a, audience box 202 lists the presenter and then the list of participants directly underneath. The presenter's name is shown on the top of the list with a line separating it from the user's name. Participants that wish to pose a query are shown to the presenter in hand-raised box 204. Hand raiser box 204 contains the names of participant that have pressed hand raise button 305 (see FIG. 3).

Directly underneath the hand-raiser box 204 there is an authorized box 208. Authorized box 208 informs the presenter who among the participants has been given authority (i.e., control) to draw on the white board and has use of audio. “Authorized: None” means that no participant has been authorized. The presenter may also grant whiteboard control directly from whiteboard 400 as depicted in and explained with reference to FIG. 4.

The presenter can also select a participant from audience box 202 to whom a personalized, private message can be sent. Whisper box 210 indicates to the presenter which participant will receive the personalized message.

A participant can be selected for whispering by clicking on a particular name within the audience list 202 and then clicking the “+” (whisper select) button 203. Then, the presenter can use the “−” (whisper deselect) button 205 to remove, participants from whisper box 210. Once a name is selected for whisper action, on master communication console 200c the presenter then enters the text in type here box 212 and presses send whisper button 214. The presenter may leave the whisper name selected, until some text is entered and send whisper button 214 is pressed. No whispering takes place from the presenter until send whisper button 214 is pressed, but the presenter may receive whisper messages from other participants in the session. As discussed below in more detail, whisper messages are displayed in whisper box 232 of both the sender and recipient of the whisper message, and in message bar 242 of the recipient of the whisper message.

On control A console 200a below hand-raised box 204, authorize and unauthorized buttons 216 and 218, respectively, are provided. Authorize button 216 allows a presenter to select one of the hand-raised persons to authorize him or her for speaking and using whiteboard 400. The name should be first selected from hand-raised box 204 before authorizing the participant. The name of the authorized participant appears in authorized box 208.

If an authorized participant already exists and another participant becomes authorized, the previously authorized participant becomes unauthorized and authorized box 208 displays the name of the next selected participant. Unauthorized button 218 allows the presenter to unauthorize a currently authorized participant. This results in an “Authorized: None” message.

Below unauthorize button 218, there is file selection combo box 220 and blank text box 222. File selection combo box 220 provides a list of files provided by the presenter and available at the server. This list may contain audio/visual avi documents or other documents. Any file presented from this list can be shown to each participant as well as the presenter. To accomplish this, the presenter selects the file and clicks the send to group button 224. The selected file is then pushed to the participant computers 120 which will display the file provided the corresponding application or viewer is already present on participant computer 120.

If the presenter types in a URL in box 222 and presses send to group button 224, a browser will open on participant computers 120 and the web page corresponding to the URL will be displayed. Provided the participants have downloaded the system's dedicated browser, the presenter can guide the participants along a web tour and authorize participants to do the same.

Below send to group button 224 there is breakout session button 226. Clicking on this button will open up a dialog box to break the session into small groups of participants.

Turning to control B console 200b, the button at the right bottom of presenter window 200 shows a microphone. This is microphone selector 260, which represents the audio streaming options and toggles between a “press to talk” and “press to stop” option. The button is in the on position (i.e., “press to stop”) as a default. When a presenter logs in, the button appears with the message: “Press to Stop” showing that the presenter is already on the air and can immediately start his speech or lecture. If the presenter wishes to stop broadcasting his or her voice, he or she simply clicks the button once to stop the broadcast and the caption will change to “Press to Talk.” This is basically a toggle button, which switches on/off by clicking on it. The same button appears on a participant's screen when that particular participant has been authorized.

Master communication console 200c, contains four text boxes: comments 228, questions 230, notes/whisper 232 and answers 234. These text boxes display the incoming and outgoing comments, questions, answers and whisper messages respectively. When a user enters text in type here text box 212 and presses one of the buttons: question 236, answer 238, and comment 240 then text is sent to every user and displayed in the appropriate box. Pressing whisper 214 sends the text only to the designated whisper recipient in whisper box 210. The text is also displayed in notes/whisper box 232 as a personal note for the sending user. If a user clicks any of these buttons (i.e., comment 240, answer 238, question 236 or whisper 214) without having inserted any text, a reminder message is flashed on message bar 242 as a reminder to enter text.

In order to track the sender of a whisper message, message sent by different participants are marked in different colors with the color corresponding to the color associated with the sender in audience box 202. This reminds the presenter and participants of a particular whispering person by identification with color. It should be noted that any user could whisper to any other user.

Log out button 248 is used to log out or exit from a session. The presenter and all participants should click this button when they are ready to leave the session. When log out button 248 is clicked, a window will appear asking if the user is sure they want to exit the session. If the user clicks “yes”, they will be removed from the session and their name will be removed from audience box 202. If the user clicks “no”, they will rejoin the session. When a participant logs out, the presenter will receive a message in their notes/whisper box 232 that the participant has left. A message will also appear in message bar 242 when a participant logs out.

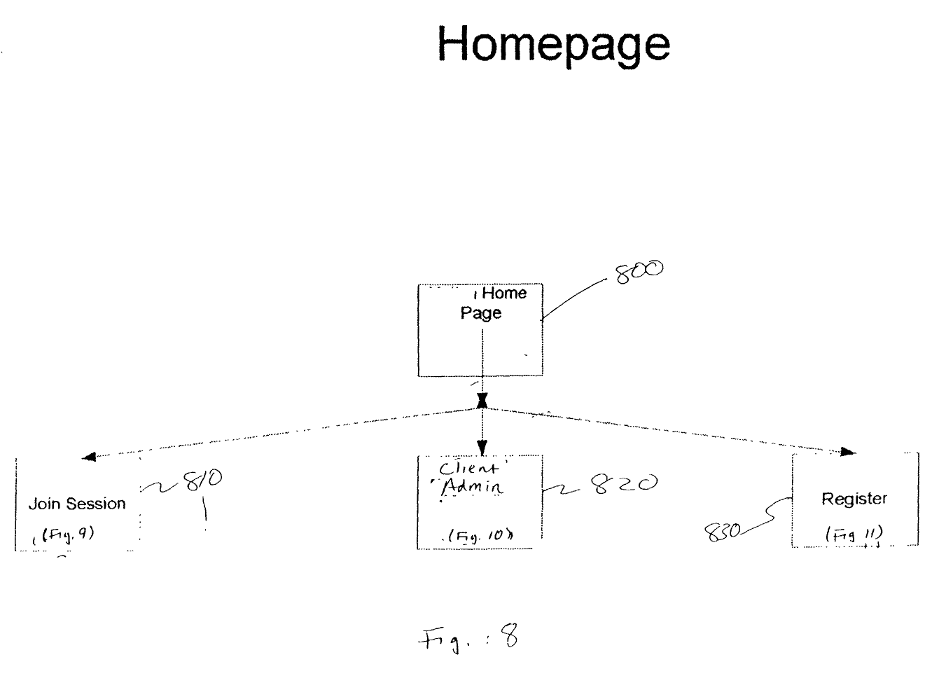

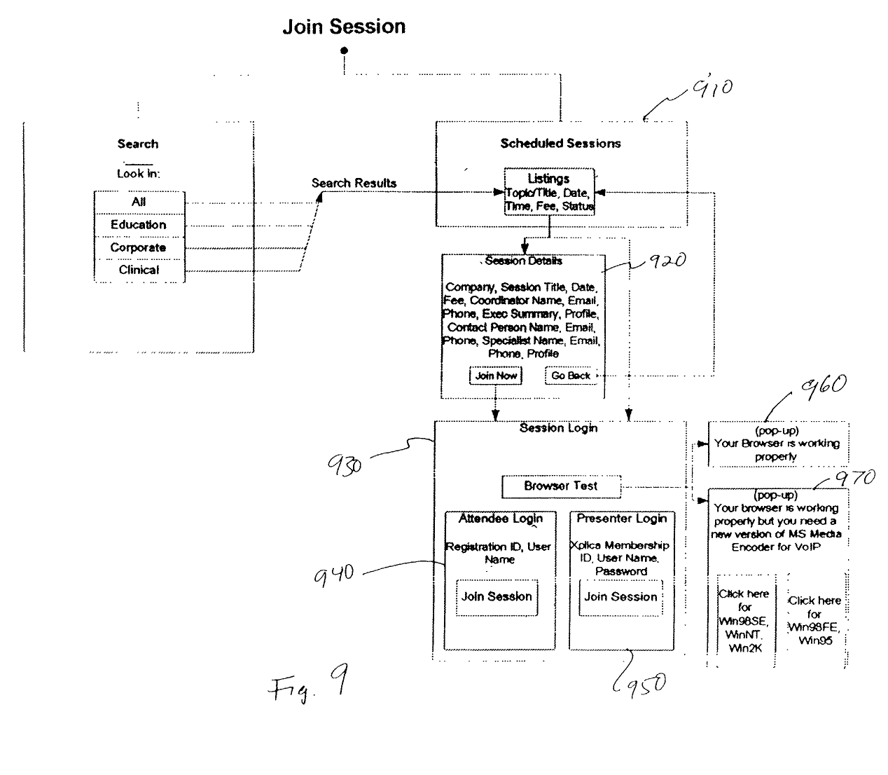

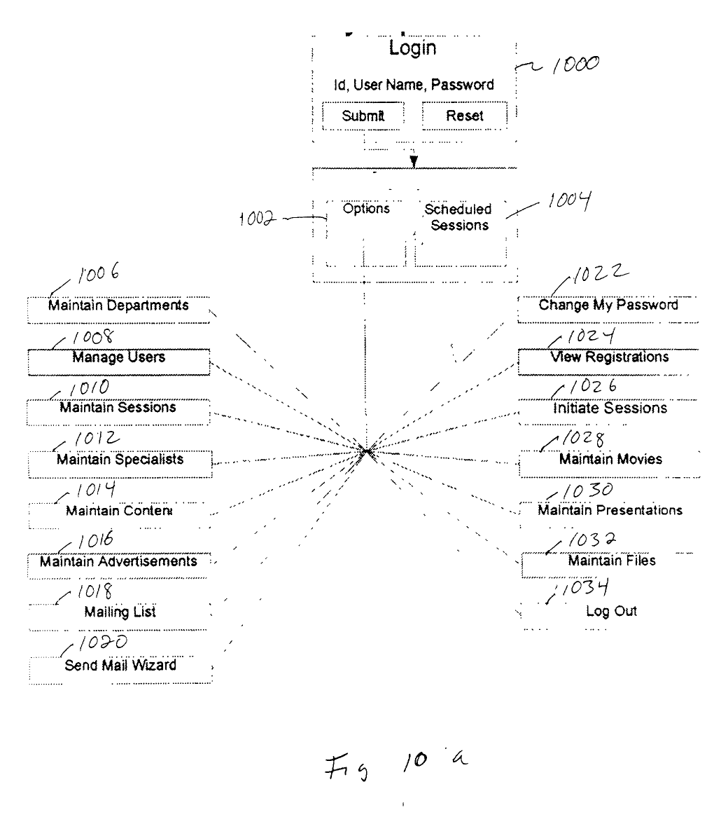

If the presenter or a participant accidentally logs out or closes their browser window, they can rejoin the session. To rejoin the session, simply, go to the Join Session screen (FIG. 9 for public sessions and FIG. 10f for private sessions) and login using the same User Name and ID that were used in the original login.

Help button 252 is located on main communication console 200c next to log out button 248. Pressing help button 252 provides a user manual to the participants and presenter regarding how to use the system.

FIG. 3 depicts participant window 300. Both presenter window 200 and participant window 300 have the same general layout. Essentially, participant window 300 (FIG. 3) provides the same view as the presenter window 200 (FIG. 2) but with less functionality. For example, participant 300 window does not include authorize button 216, unauthorize button 218, send to group button 224, breakout session button 226, answer button 238, whiteboard button 244, microphone selector 260 (unless authorized), poll button 246, result button 256, or attendance button 258. However, participant window 200 does include some added functionality such as raise hand button 305. Like buttons on participant window 300 provide the same functionality as those on presenter window 200. Additional presenter buttons appear on participant window 300 to give the participant limited presenter like control, such as the ability to speak (microphone selector 260), when authorized by the presenter.

Also on participant window 300 is audio message bar 310, which indicates the audio streaming status, such as audio active, buffering and playing. This allows both the presenter and participants to keep abreast of the audio media player status and coordinate full duplex speech. When the presenter authorizes a participant to speak, audio message bar 310 also appears in the lower right-hand corner of presenter window 200 just below microphone selector 260. Audio message bar 310 will first display the words “Audio Active” to indicate the system is ready to hear the authorized participant. Once the authorized participant speaks, audio message bar 310 will indicate “buffering” while the audio is buffered and then “playing” when the voice is output. Audio message bar 310 is always present in participant window 300 but only appears on presenter window 200 when a participant is authorized. Since FIG. 2 indicates that no one is authorized, audio message bar 310 does not appear.

Referring now to FIG. 4, shown is whiteboard presentation tool 400 of the present invention from the view of the presenter (FIG. 4a) and the view of an unauthorized participant (FIG. 4b). Whiteboard button 244 on the presenter menu (FIG. 2) is used to activate whiteboard 400 for display of presentation slides, and to draw on whiteboard 400 and send the drawing to the participants. If whiteboard 400 is not opened, the presenter simply clicks on whiteboard button 244, which makes whiteboard 400 appear to every participant computer 120 in the session.

Content can be added to whiteboard 400 prior to the session. In addition, any type of static content can be used in whiteboard 400, such as images, presentation slides, documents, and spreadsheets. Whiteboard 400 also allows users to create new content using blank slides. Content that is loaded into whiteboard 400 does not require any data conversion by the presenter. The presenter can load static content (as opposed to videos or other files that include motion) in any standard file type. Note that slides with animations can be loaded into whiteboard 400, but the animations will not show during playback. Content may be used and displayed on the participant computers 120, even if the participant does not have the corresponding content application resident on participant computer 120. Server 140 provides an automated conversion process (driven by conversion engine 145) to allow this functionality. The process for PowerPoint content is described below in the Automated PPT Conversion section. Although other formats can be used, the preferred embodiment of the present invention converts MS PowerPoint (PPT) format files for presentation on whiteboard 400. Other file types are first converted into PPT format before entering the conversion process of the preferred embodiment.

As depicted in FIG. 4a, color selection tablet 405 on whiteboard 400a allows the presenter to draw text, objects, or other annotations in the color of his/her choice by allowing the presenter to select a color from color selection tablet 405 for the desired annotation tool. Whiteboard 400 includes a full array of annotation tools including: text button 410 to write text, line button 415 to draw lines and curves, oval button 420 to draw circles and ovals, rectangle button 425 is used to draw rectangles and squares, freehand button 465 to draw anything by hand like a pen on whiteboard 400.

These buttons all activate well-known standard annotation tools and operate in a similar manner to those on many commercially available drawings programs. Generally, the presenter (or participant when authorized) selects the annotation tool by pressing the appropriate button. Next, the presenter clicks on the board area where they wish to start the annotation from and then drags it to its end point by the left button of the mouse pressed. The presenter can clear the drawing annotations by using select button 450 to select the annotations and then pressing clear button 470.

Annotations can be added to any existing whiteboard 400 or they can be created on a new, blank whiteboard 400. To open a blank screen, the presenter selects erase all button 475 before using the desired annotation tool. Erase all button 475 clears the entire screen of both the annotations and the slide content.

As a safety precaution, annotations on whiteboard 400 are not automatically sent to the participants. In order to send the drawings, the presenter presses send button 445. The annotations made by the presenter will then appear on participant whiteboards 400b.

At the bottom of whiteboard 400, topics list box 430 appears carrying the topic names of presentation slides. The presenter before the start of the session must supply these names while uploading the presentation(s). Previous button 435 and next button 440 are available to navigate through the presentation slides. If topics do not appear the first time, the presenter simply presses next button 440 to reinitiate the topic selection. If no topic is available, next and previous buttons 435 and 440 will have no effect.

The participant's view of whiteboard 400, shown in FIG. 4b, is slightly different than the presenter's view, shown in FIG. 4a. The toolbar does not appear on the participants' view, unless the participant is authorized. When the presenter authorizes a participant to control whiteboard 400, that participant's toolbar will be activated (and visible) on FIG. 4b in the same manner as seen from the presenter's view in FIG. 4a. When the presenter unauthorizes the participant, the toolbar will again automatically be removed and the whiteboard 400b will return to the view shown in FIG. 4b.

In order to be authorized, a participant must request authorization from the presenter. The participant pressing hand-raise button 480, as shown on FIG. 4b, generates the authorization request. This will cause hand indicator 485 on both the presenter and participant's whiteboard 400 to change colors indicating an authorization request. The names of all participants that have raised their hands will appear on hand-raisers list box 490 on FIG. 4a. The presenter then selects a participant from hand-raisers list box and presses authorize button 492 to provide the selected participant control of whiteboard 400. The presenter can unauthorized the selected participant by pressing unauthorized button 494. Video conferencing button 496 on participant whiteboard 400b activates the video conferencing feature of the system, which is described in more detail in the Media Streaming section below.

Thus, the presenter can hand off the controls to an authorized participant so they can both share the driver's seat. The ability to share controls with the participants enables the session to be truly interactive. Once the presenter authorizes a participant, that participant can then navigate through the slides and annotate. The authorized participant's microphone is also activated, so the other participants can hear both her and the presenter's voices. Details are provided below in the Audio Streaming section.

When a participant is authorized to control whiteboard 400, the presenter continues to also have access to the controls. Using full duplex audio streaming, both the presenter and the authorized participant can speak with each other at the same time, like with a telephone. The presenter also maintains the ability to unauthorize the participant, thereby removing their control of whiteboard 400.

First, if a participant would like to ask a question or take control of whiteboard 400, she must raise her hand using raise hand button 480. When the presenter is ready to share the controls, the presenter selects the participant's name from hand-raised box 204 and clicks authorize 216, or from hand-raisers list box 490 and clicks authorize button 492. The participant will then receive the controls causing an “audio active” message to appear in audio message bar 310 and microphone indicator 260 to appear on participant window 300 just above audio message bar 310. Additionally, message bar 310 indicating “audio active” will also appear on presenter window 200 as previously described.

When the participant is finished (or actually at anytime whether the authorized participant is finished or not), the presenter can click unauthorize button 218 or unauthorized button 494 to remove the controls. Only the presenter and one participant can share the controls at a given time, but once one participant is unauthorized, another can be given the controls.

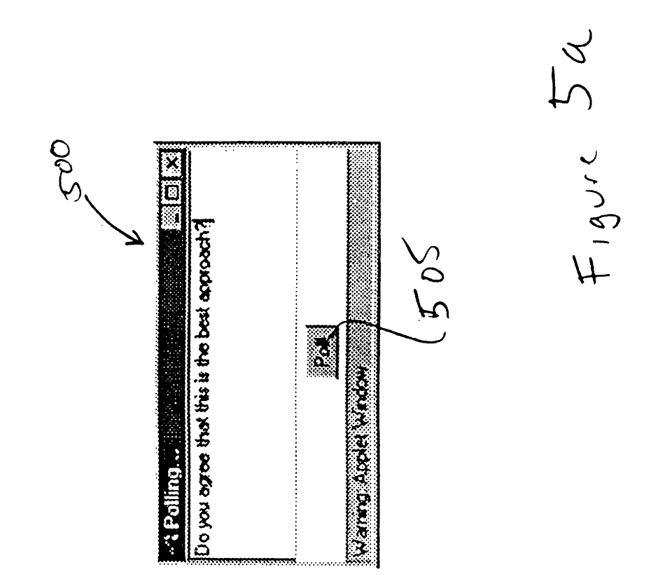

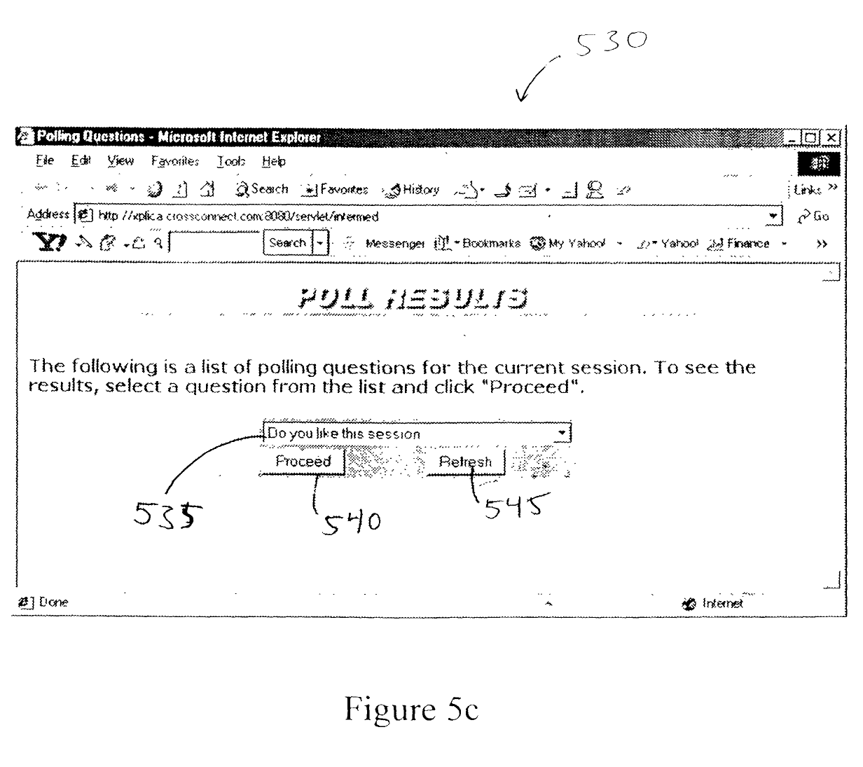

Turning back to presenter window 200 (FIG. 2), poll button 246 on master communication console 200c allows the presenter to poll the participants. Pressing poll button 246 results in a small window 500 appearing with a text box (FIG. 5a) to type in a question and send it to the participants. Pressing poll button 505 on polling window 500 causes the polling question to be sent to all participants. When the presenter clicks on poll button 505, a small polled window 510 appears on the participants' screens and the participants are given the option to answer by pressing any one of the buttons available in the window (i.e., “Yes” 515, “No” 520, and “Not Sure” 525) (FIG. 5b). These labels can be changed. The presenter may then view the list of polled questions (FIG. 5c) and a graphical representation of the polling results for each question (FIG. 5d).

Additionally, using master communication console 200c, the presenter may view the poll results during a session by clicking poll-result button 256. As shown in FIG. 5c, when the presenter clicks on poll result button 256, a new window 530 appears displaying a list 535 all the questions asked during a particular session. The presenter can select any one of them, by highlighting the selection and clicking proceed button 540. A graphical representation of the results will appear as shown in FIG. 5d. The participant may press refresh button 545 to refresh the question list displayed in drop down list 535.

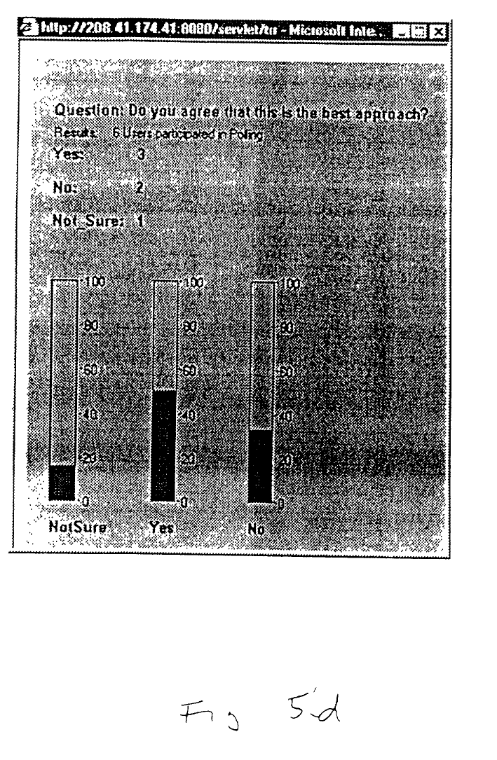

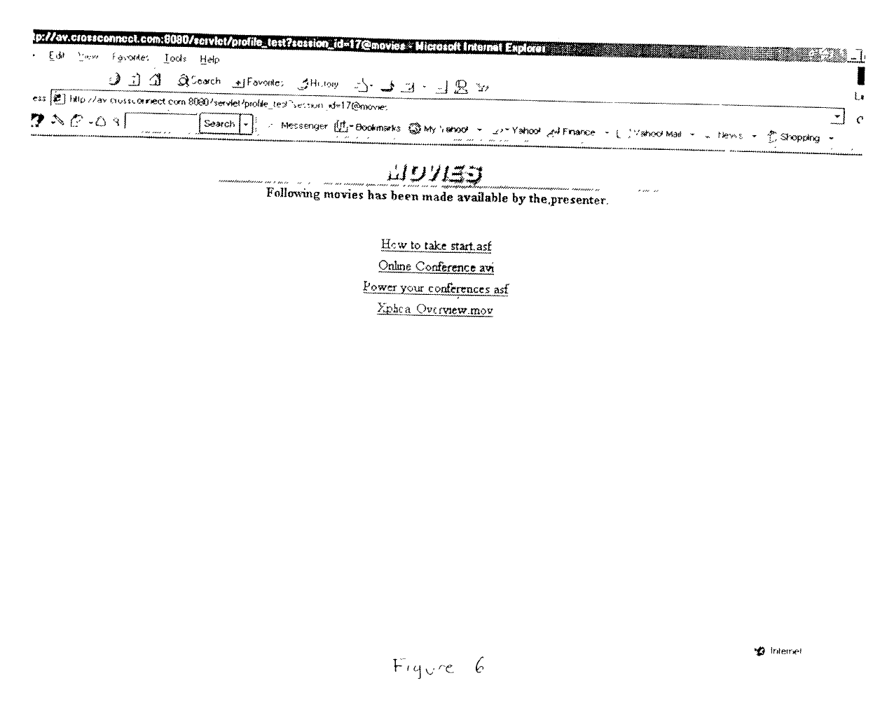

Continuing with FIG. 2, in the grouping of buttons with poll button 246 which appear on the right side of master communication console 200c, movie button 250 and content button 254 are present. By pressing movie button 250, presentation window 600 appears as depicted in FIG. 6. Referring to FIG. 6, a user can select any of the links to watch a particular movie. FIG. 6 is representative of the presenter view, participant view and the authorized participant view.

Turning back to FIG. 2, content button 254 appears on the right side of main communication console 200c as well. Upon pressing content button 254, presentation window 600 appears on the participant computer carrying hyperlinks to suggestive and informative material uploaded by the presenter for a particular session as depicted in FIG. 6. The content files may be in any standard file format.

Located near the top of control A console 200a is attendance button 258 that the presenter can use to see the session joining time of each user during a session. When attendance button 258 is clicked, a new attendance window 700 will appear as shown in FIG. 7. In attendance window 700 will be a list 710 of the participants' user names along with the time they joined the session. To return to presenter window 200, the presenter simply closes attendance window 700.

GUI Navigation

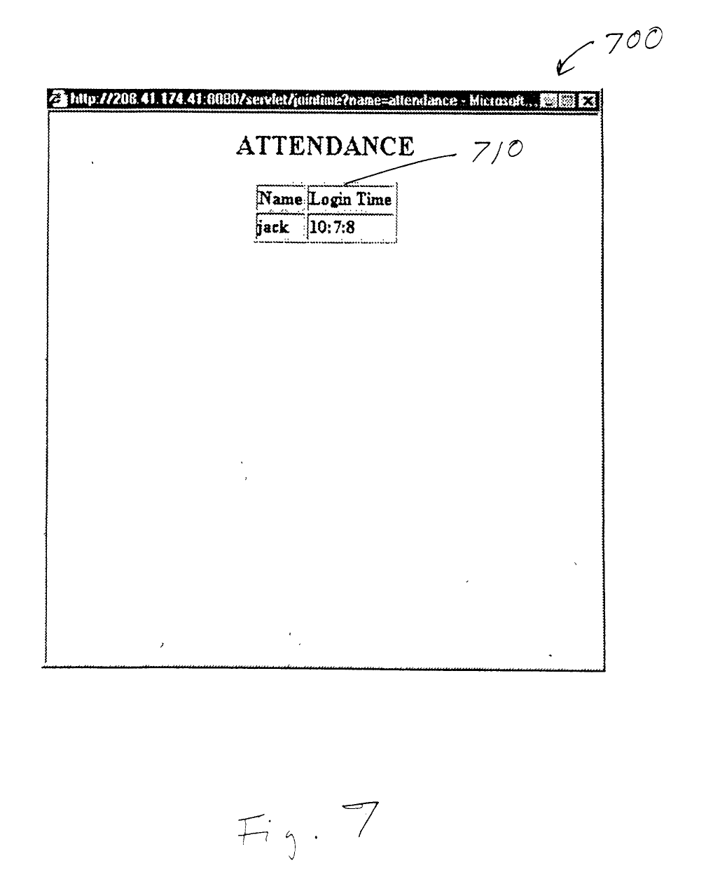

The navigation through all of the GUI's for registration, joining sessions and administrative purposes are depicted in FIGS. 8-11. Among the many functions accessed via the GUI structure (FIGS. 8-11), as shown in FIGS. 10d and 10f, the presenter and participants navigate the GUI's to reach presenter window 200 and participant window 300, respectively. The functionality for controlling GUI navigation and allowing client administration is provided by back-end application 185 (see FIG. 1).

FIG. 8 depicts the structure of system homepage 800 accessible to anyone via the Internet. From the system homepage, a user has three options 1) join a session 810, 2) access client administration 820, or 3) register 830 as a user on the system.

Selecting join session option 810 provides participants and presenters with access to the publicly available sessions on the system. Only participants in public sessions access the system via join session option 810. Join session option 810 leads the user to the menu structure depicted in FIG. 9. Users can choose from a listing of scheduled sessions 910 and view the session details 920. Session login menu 930 provides users access to the selected session, participants via menu 940 and presenters via menu 950. Upon accessing session login 930, the system checks the users web browser to test for the presence of a current version of the Microsoft Media Encoder. The system either validates the presence of the encoder 960 or prompts 970 the user to obtain the current encoder. As discussed below in the audio streaming section, the encoder is necessary for audio streaming.

Selecting client administration option 820 provides the user access to client private sessions and client specific administration functions accessible via the menu structure depicted in FIGS. 10a-f. FIG. 10a provides an overview of all of the available client administrative options, while FIGS. 10b-e provide the detail of the menu structure underlying each menu option. FIG. 10f provides the detail of the menu structure for accessing client-scheduled sessions.

As depicted in FIG. 10a, upon selecting client administration option 820, the user is prompted by menu 1000 to login to the system. Once logged in, the user selects access either to administrative options 1002 or scheduled sessions 1004. The various administrative options include menus to maintain departments 1006, manage users 1008, maintain sessions 1010, maintain specialists 1012, maintain content 1014, maintain advertisements 1016, configure mailing lists 1018, access send mail wizard 1020, change passwords 1022, view registrations 1024, initiate sessions 1026, maintain movies 1028, maintain presentations 1030, maintain files 1032 and log out 1034. Each option is depicted in detail in FIGS. 10b-e, which are self-explanatory. These option menus are for use by the client's system administrator and presenters. Of note, a presenter accessing initiate sessions menu 1026, after selecting from a listing of sessions, is directed to presenter window 200 for the selected session.

Selecting scheduled sessions 1004, instead of options 1002, leads the user (typically presenters and participants) to the menu structure depicted in FIG. 10f for accessing the client's private sessions. Participants select from a listing of sessions to either pre-register 1036 for an upcoming session or join 1038 a session that has started or is about to start. Profile information, such as the title, topic, date, time, fee and status, for each session are displayed on scheduled sessions menu 1004. The registration process leads the participant through registration form 1040 followed by registration confirmation menu 1042. Once the registration is confirmed, the participant may search other ongoing sessions 1044 for which the participant may pre-register 1046 (via registration form 1040) or join 1048 (via session login menu 1050).

To join a session, the participant accesses join session menu 1050 via join option 1038 on scheduled session menu 1004 or join option 1048 from ongoing session menu 1044. Also, presenters access session login menu 1050 via join option 1038. Upon access to join session menu 1050, the system performs the same browser check that was performed with respect to join session menu 930 (see FIG. 9) and described above. After the user logs on as either a participant 1052 or presenter 1054, the user is directed to participant window 300 (see FIG. 3) or presenter window 200 (see FIG. 2), respectively.

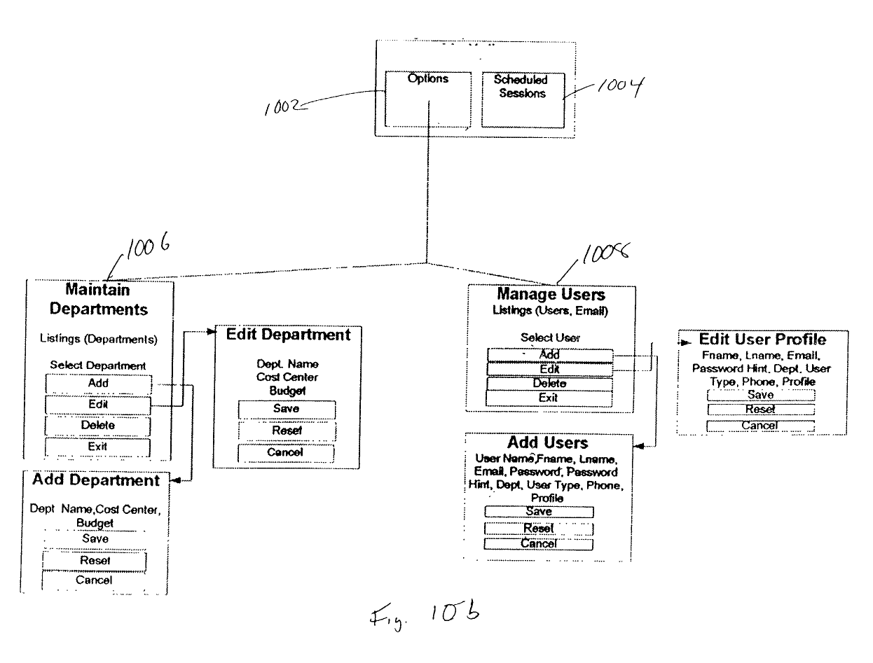

Selecting registration option 830, provides the user with the client setup features of the system via the menu structure depicted in FIG. 11. From these menus, the user begins the client setup procedure by specifying the account type (e.g., corporate, university, clinical), user name, password and a password hint via client setup menu 1100. The user is then directed to either company setup menu 1110, university setup menu 1120, or clinic setup menu 1130, respectively depending upon the account type, where the user inputs critical contact information such as the client name, industry, contact name, telephone, address, and the like. Once the information is input, the user is directed to a corresponding setup confirmation menu 1140, 1150 or 1160, respectively depending upon the account type.

As explained above, the system may administer multiple clients and schedule multiple sessions for each client. The administration and accounting for multiple clients from the internal system administration perspective is handled by administration application 190 (see FIG. 1).

Advertisements

The system includes an automated advertisement placement capability to provide the opportunity for direct consumer marketing. As shown in FIGS. 2 and 3, advertisements 262 appear in the top of control B consoles 200b and 300b, respectively. The advertisements have active http links to designated URL's.

Control B consoles 200b and 300b provide space for two advertising links. Any image or animation can be inserted here along with a hyperlink to any desired web site. The advertising images are added from the backend management tools of the system when the session is setup. The advertisements are used to direct participants to any web-based content, or for specific e-commerce opportunities. If desired, the image can simply show a picture of the presenter.

The system allows the addition of advertisements to a company's database for use in future sessions. The ads can be any standard image type, logo, or photograph combined with a hyperlink to any live web site.

When the presenter or participants click on an advertisement during the session, that user will have a new browser window open on their desktop. The new browser will be directed to the URL specified by the presenter when the session was setup. The user can then navigate the new browser, as appropriate. To return to the session, the user must simply click the minimize button.

Using maintain advertisements option 1016 (FIG. 10a), a user may add, edit, or delete advertisements on the presenter's company profile as depicted in FIG. 10c. Manage advertisements screen 1017 appears showing the advertisements that are currently assigned to sessions.

Advertisements are added sessions in the company profile. To add advertisements, select ADD 1017a on manage advertisements screen 1017. The following required fields are then entered via add advertisement screen 1019:

1. Session—Select the session to which you wish to add the advertisement

2. First Advertisement

3. First File

4. First URL

5. Second Advertisement

6. Second File

7. Second URL

To edit advertisements, the user goes to manage advertisements screen 1017. The user then highlights the advertisements to edit and selects EDIT 1017b. Edit advertisements screen 1021 appears so that edits may be made to the required fields.

To delete advertisements, the user highlights the advertisement to delete, then selects DELETE 1017c on manage advertisements screen 1017. A message box appears stating: “Are you sure you want to delete “XYZ” advertisement?” The user selects OK to delete the selected advertisement or CANCEL to return to the previous screen.

Automated PPT Conversion

The system also includes an automated application to convert and place Microsoft PowerPoint slides for the session to be displayed on whiteboard 400. The platform is Microsoft Windows NT Server, 2000 Server and the application is written utilizing the Microsoft Visual C++ v6.0 Enterprise Edition programming language. The automated conversion process allows the presenter to display a presentation on whiteboard 400b on participant computers 120 without the need for the presentation application to be present on participant computers 120 or the download of any applications or plug-ins to participant computers 120. The detailed description of the conversion process and structures described below focuses on PowerPoint format presentation files. However, one of ordinary skill could adapt the process to accommodate other presentation formats, such as Harvard Graphics or Freelance.

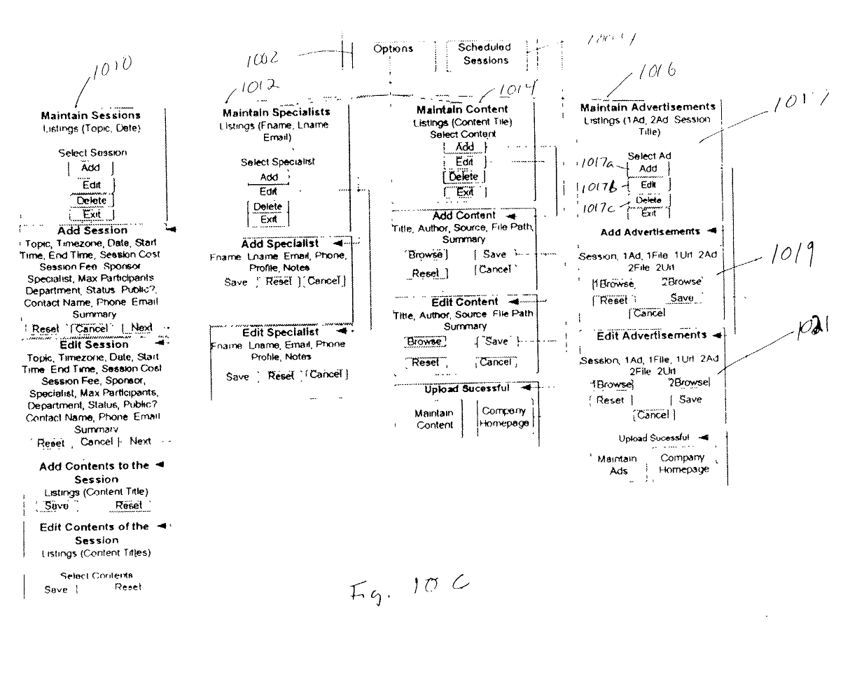

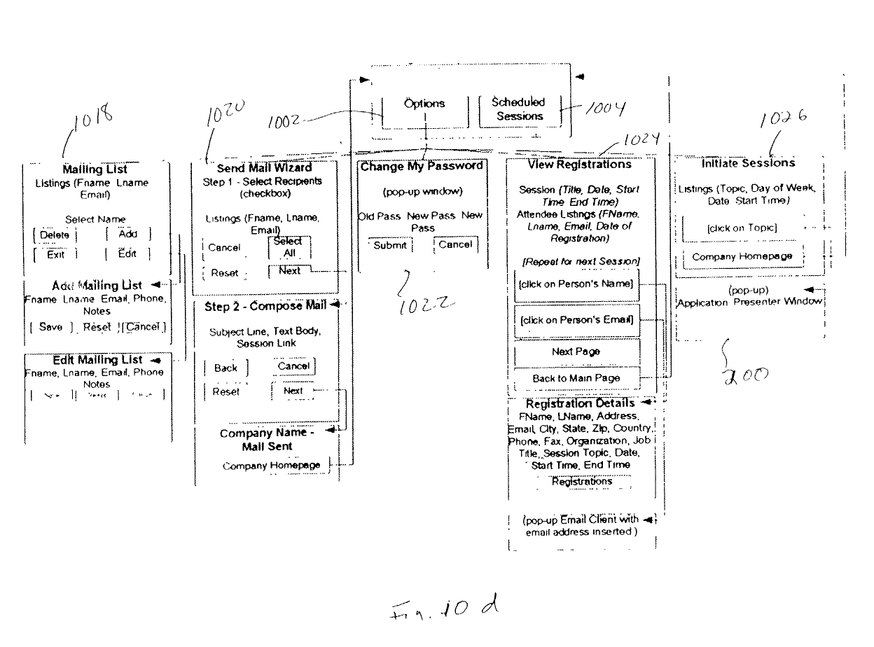

The interaction of PPT automate engine 1200 with the overall system as well as with the user is depicted generally in FIG. 12 and in more detail in FIG. 13. All of the structures depicted in FIG. 12 are contained within server 140. These structures include PPT automate engine 1200 which is included within conversion engine 145, presentation database 1205 within database 165, web published directory 1210 within web server 155, whiteboard application 150, core engine 175 and session manager 1225.

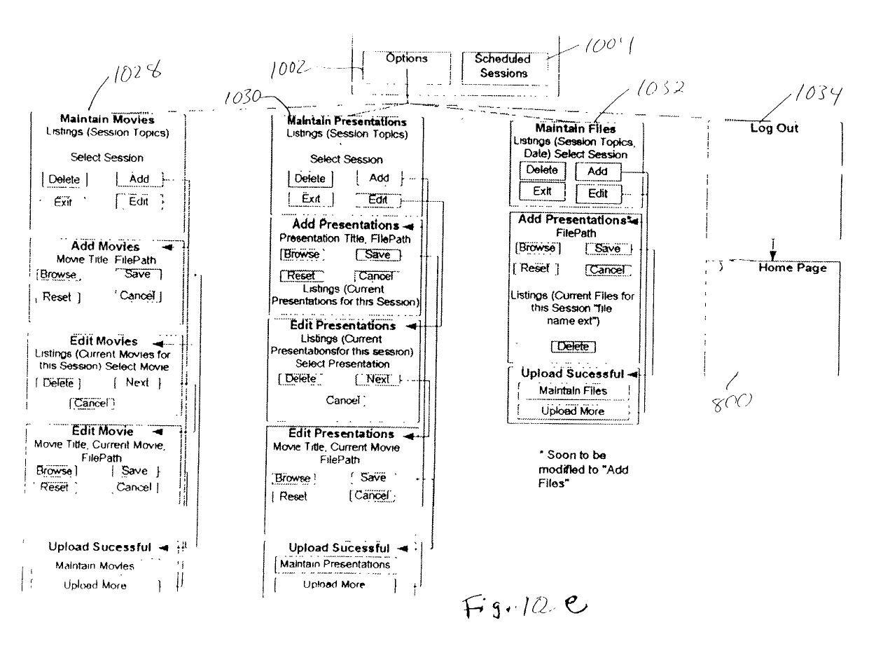

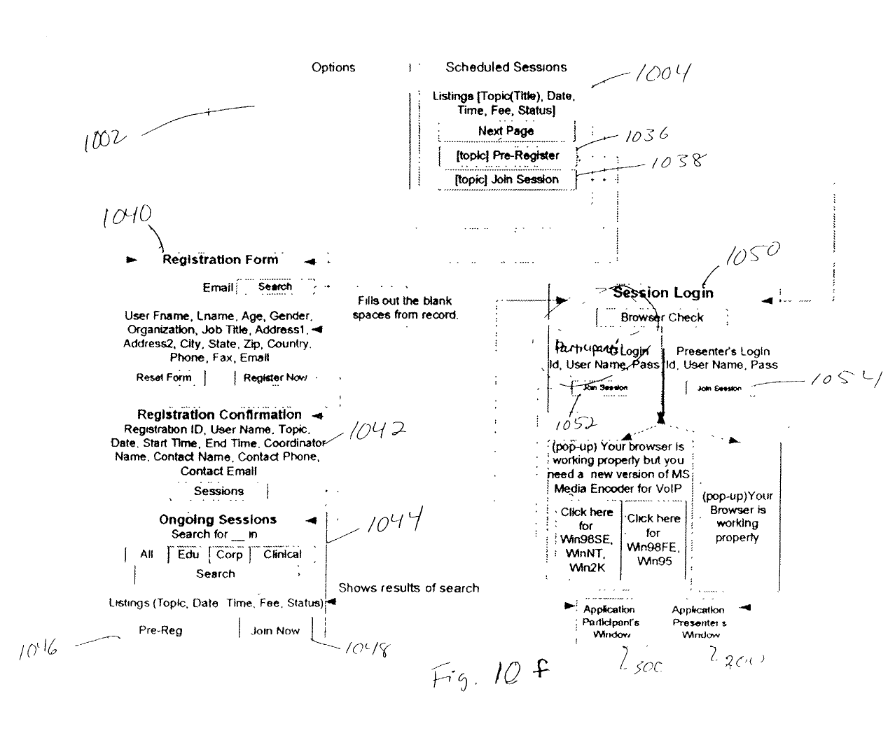

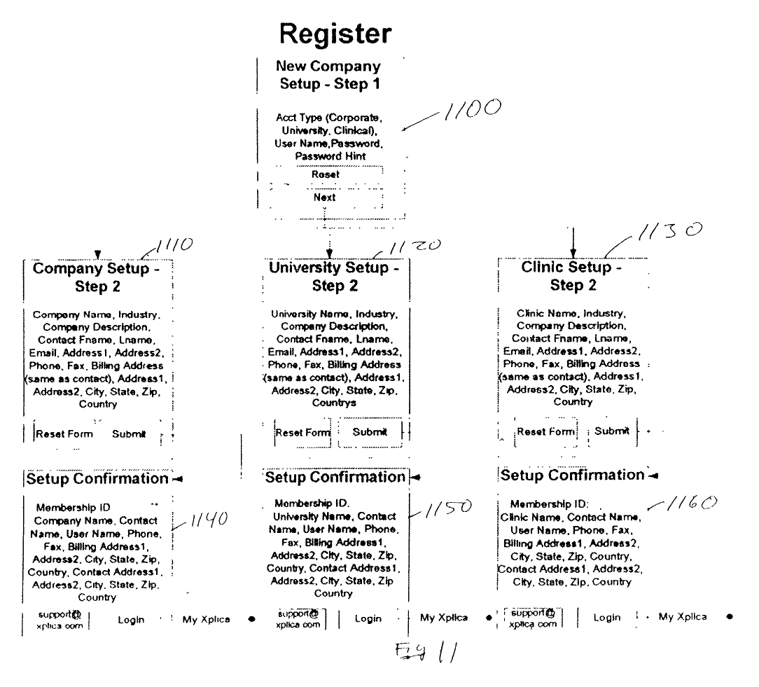

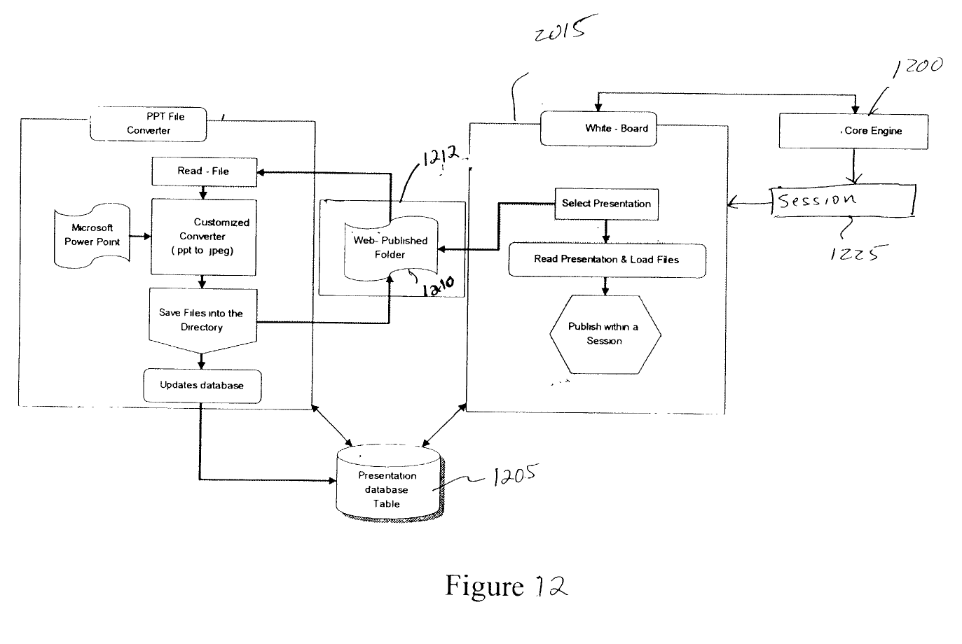

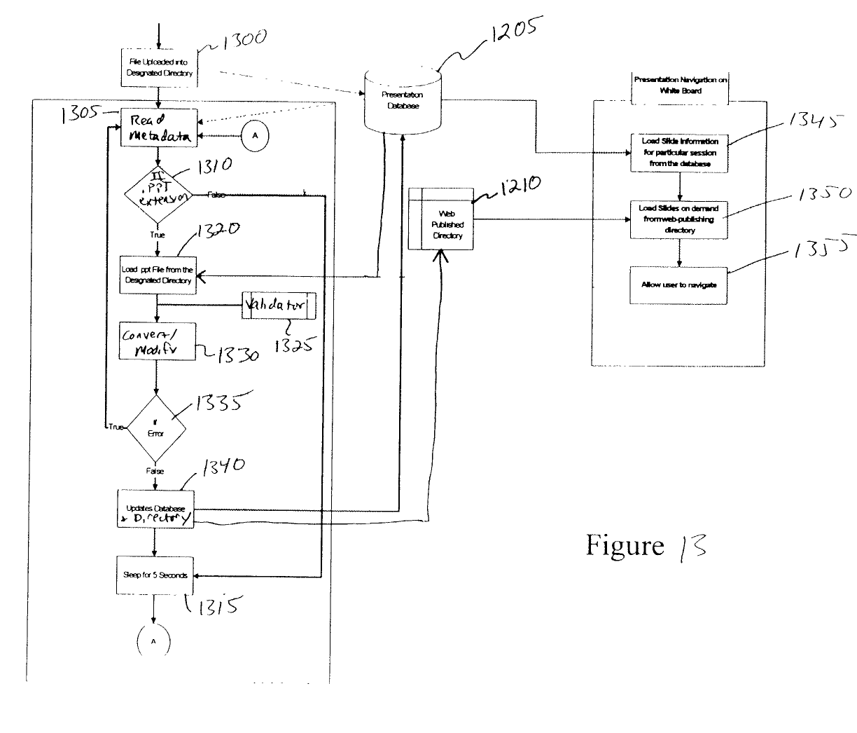

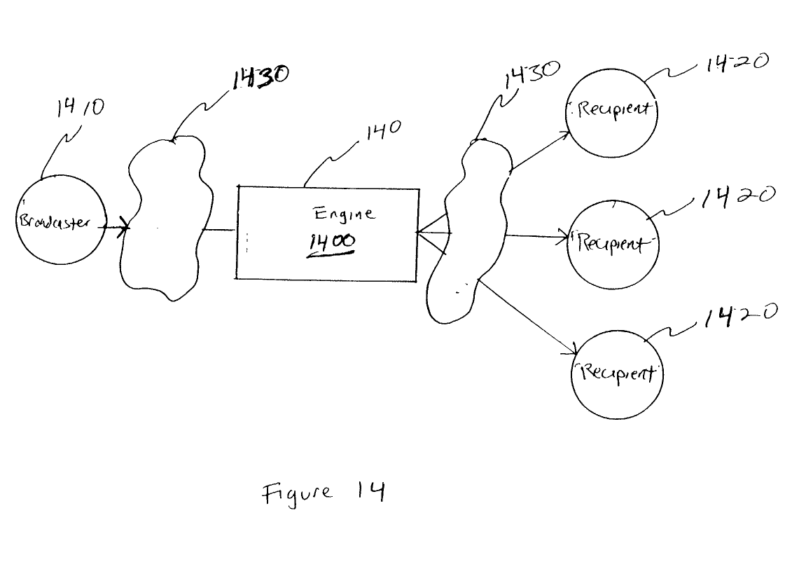

PPT automate engine 1200 facilitates the conversion of PowerPoint presentations for display on whiteboard 400, as explained below in reference to FIG. 13. Additional detail is provided below with respect to FIG. 14. Engine 1200 interacts with presentation database 1205 and web published folder 1210 for retrieving uploaded presentations from users and storing converted presentations for display on whiteboard 400 by whiteboard application 150.

Presentation database 1205 and web published folder 1210 are resident on the same storage device but could be easily distributed among multiple devices. Presentation database 1205 is segmented by client account so that only user's from different clients are segregated. PowerPoint files uploaded by users as well as corresponding metadata are stored in presentation database 1205. The metadata includes data such as client information, session information and conversion status information (i.e., conversion status field 1230).

Web published directory 1210 stores the converted presentations in JPEG format separate from presentation database 1205 due to the large size of the JPEG files. This allows more rapid access to presentations by whiteboard application 150, which is necessary to provide seamless slide show presentations to participants. While the original PowerPoint format file remains in presentation database 1205 for an extended period, converted presentations are removed from web published directory at the end of a session due to the large file size.

Under the control of core engine 180 and in conjunction with session manager 1225, whiteboard 400 is the presentation medium for the converted presentations stored in web published folder 1210, which is a secure folder only accessible from whiteboard application 150. Whiteboard application 150 accesses presentations from web published folder 1210 for presentation and metadata from presentation database 1205 for validation.

Turning to FIG. 13, the interaction processes between PPT automate engine 1200, presentation database 1205, web published directory 1210 and whiteboard application 150 is depicted in detail. To upload and convert presentation files, a user, typically the presenter or the client's system administrator, logs into the system and selects options feature to access options menu 1010 as shown in FIG. 10A. Assuming a session already exists, the user selects maintain presentations 1020 to access maintain presentation menu 1050 and then add 1055 to access add presentations menu 1060 as shown in FIG. 10e. The user then selects browse 1065 to choose the presentation and then save 1070 to upload the file to presentation database 1205. The system then uploads 1300 the presentation to presentation database 1205 as shown in FIG. 13.

Independent from uploading 1300, at the start of the PPT automate engine 1200 process, engine 1200 periodically checks (every few seconds) to detect newly uploaded files to presentation database 1205 and reads 1305 the metadata. Engine 1200 then determines 1310 if the file for which the metadata was read has a PPT PowerPoint file extension. If it is not a PPT extension, engine 1200 waits for a pre-determined time (programmable to any time set but preferably 5 to 15 seconds) 1315 before again reading 1305 metadata from presentation database 1205. If it is a PPT extension, engine 1200 loads 1320 the PPT file from presentation database 1205.

Format validator/dispatcher 1325 then validates that the file is in fact a PPT format file by examining the header information of the file and dispatches the file to the converter algorithm. Once validated and dispatched, engine 1200 using a converter algorithm then converts the slides in the PPT file into a series of JPEG format files and modifies the resolution (i.e., size) and format of the JPEG file 1330 for display on whiteboard 400. Engine 1200 uses the PowerPoint COM Interfaces to convert the slides into a series of “jpg” (JPEG) images and modify the resolution. The JPEG files are modified from their standard resolution to 400×300 pixels. The PowerPoint application does not open the PPT file but merely performs the format conversion.

Engine 1200 then checks the converted and modified JPEG file to validate 1335 the conversion and modification process (i.e., correct resolution). If there is an error, engine 1200 returns to read step 1305. If there is not an error, engine 1200 performs update/write step 1340 in which engine 1200 updates the metadata in presentation database 1205 to indicate a successful conversion and writes the converted file to an appropriate location in web published directory 1210 so whiteboard application 1215 of the particular session can gain rapid access. The PowerPoint application and the COM engine are then un-initialized, and the conversion status field in presentation database 1205 is marked to flag the conversion of the particular file. Engine 1200 then waits 1315 before re-initiating the process by reading 1305 the metadata from presentation database table 1205 again.

Turning to whiteboard application 150, slide information (i.e., metadata) is loaded for a particular session from presentation database 1205. Then, the JPEG format of the slides are loaded 1350 on demand from web published directory 1210. The presenter can then navigate 1355 the slides using the buttons on whiteboard 400a to control the slide show seen by the participants on whiteboard 400b.

A color-coding scheme is used to mark the progress of the conversion (based upon the data in the conversion progress field) for the user to indicate that engine 1200 is: waiting for a new PowerPoint presentation to be uploaded; checking presentation database 1205 for a newly uploaded files; or converting the PowerPoint presentation into a series of JPEGs and placing them in web published directory 1210.

The aspects of the system architecture, which support the whiteboard functionality are depicted in FIG. 22 and described in the system architecture section below.

Media Streaming

The concept of audio streaming is not new in IT. Still streaming data is an underdevelopment technology. Till now there are no standard defined by any of the standard defining organizations such as IEEE, IS0 9000 & etc. There are various formats available for streaming media, offered by different companies. All the formats have been developed by independent parties which results in separate download and installation for each parties player or plug-in, such as RealTech™ G2. Additionally, Microsoft provides a streaming media platform built into the Windows operating system. These built-in “Windows Media Components” are predefined and made available in Windows 98 (2^{nd} ed.), Windows 2000 and higher versions. Although older versions of Windows do not have these components, upgrade patches to install the media components are readily available from Microsoft. Additionally, independent developers can embed the patches or link to the patches in their product for those users who lack up to date operating systems.

The preferred embodiment of the present invention utilizes Microsoft's Windows Media Encoder. As described with respect to FIG. 9, the system checks and updates, if necessary, the media encoder files of the remote computer's web browser.

As depicted in FIG. 14, in order to control the transmission and reception of the live audio stream, server 140 using media engine 1400, which is part of media engine 170 (media including audio, video and the like), must administer the encoder at both broadcasting computer 1410 (possibly presenter computer 100, specialist computer 180, or an authorized participant computer 120a) and recipient computers 1420 (all computers 100/120/180 other than the broadcast computer 1410) via the Internet 1430. Server 140 retrieves pointers to the encoder agents from broadcasting computer 1410 and recipient computers 1420 that are running the encoder engines. Media engine 1400 (primarily constructed in C++ (ATL)) on server 140 acts as an administrator using Java Server Pages (JSP) sent by server 140. Moreover, media engine 1400 utilizes DCOM (Distributed Component) to communicate (internal bridging is done with JSP) between server 140 and the remote computer (i.e., broadcasting and recipient computers 1410 and 1420).

The agent locator can be global in scope and be available to media engine 1400 whenever the JSP page containing the locator is accessed. However, the encoder agent and the selected encoder engines have session scope. As a result, multiple encoder agents do not need to be created to handle multiple requests for encoder objects during a single session.

The system of the present invention also provides full duplex audio streaming components on server 140. The components are primarily constructed in C++ (ATL). In order to control the flow of media streaming (i.e., direct the IP tunnel) to enable recipients to listen to the media stream, Java Server Pages (JSP) (in particular, listening.jsp as shown in FIG. 17a) are used by the system.

FIG. 15 depicts the audio and video streaming architecture in relationship to presenter computer 100, participant computers 120 (authorized 120a and unauthorized 120b) and application server 140 (in particular, web server 155 and database 165). When the presenter logs into web server 155, login information including the presenters IP address and user name are provided to web server 155. The login information allows the system to identify the presenter when speaking and provide a tunnel to the IP address of presenter computer 100. On authorization, web server 155 recognizes the IP address of the authorized participant and pushes the control (see System Architecture section below) to the authorized participant computer 120a based on the IP address, which grants authorized participant computer 120a control over the IP tunnel.

Live media streaming is facilitated by the creation of an IP tunnel between presenter computer 100 and participant computers 120 through web server 155. While web server 155 facilitates the IP tunnel, web server 155 does not process the live audio stream during presenter to participant audio/video communications.

In terms audio and video streaming there are three types of users—the presenter, authorized participant (or specialist) and unauthorized participants. The presenter has all the controls in default and can send and receive the media by default. Unauthorized participants can only receive the media stream and are prevented from transmitting a media stream.

Server 140 streams two basic types of media to users: on demand media files (i.e., clips) under the control of media server 195, and live media under the control of media engine 170. Both types of media streaming are discussed below.

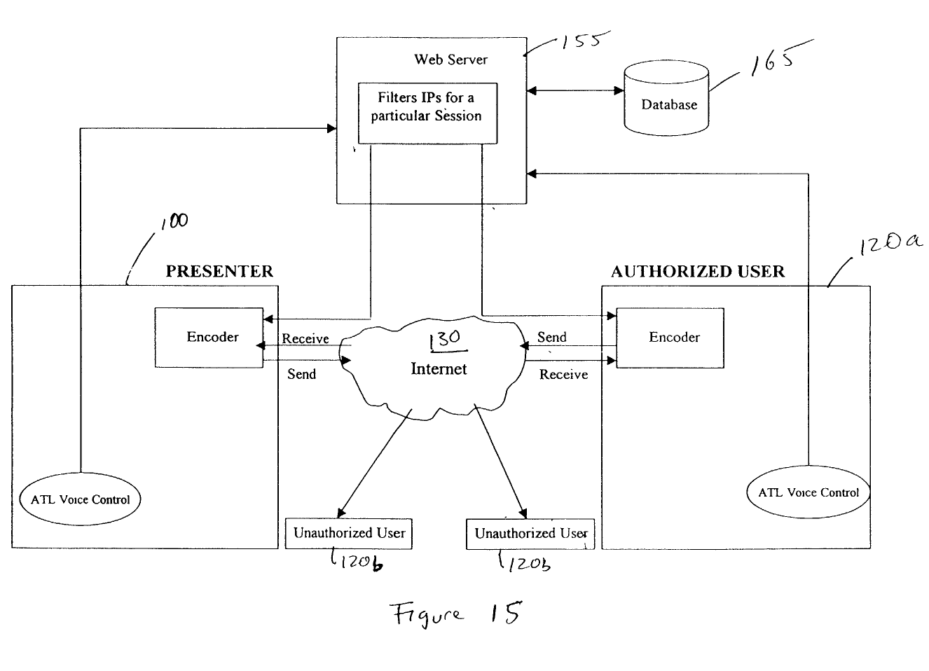

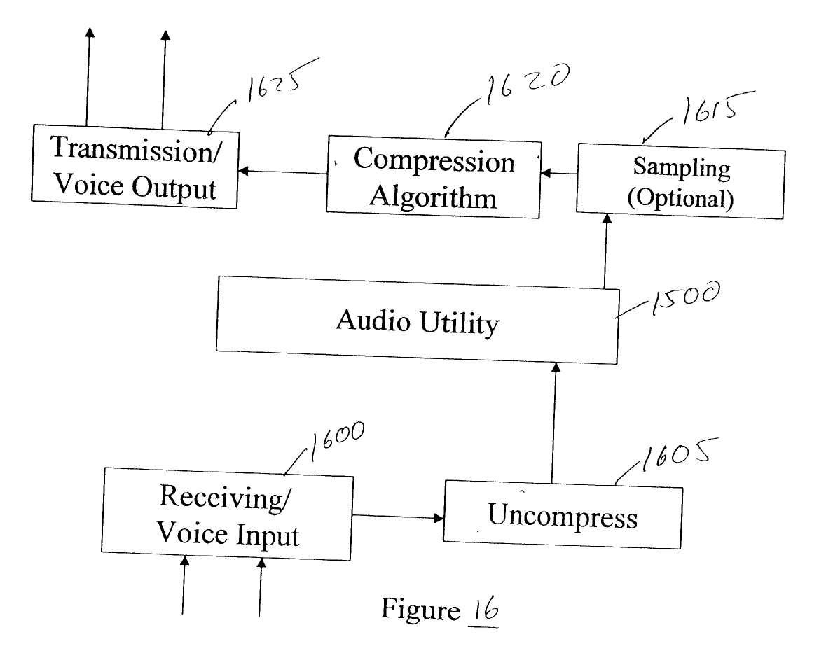

On demand audio and video files are streamed to presenter computer 100 and participant computers 120 from media server 195, while the clip information (i.e., metadata) is posted to and accessed from database 165 via web server 155 (see FIG. 1). Presenter computer 100 and participant computers 120 are connected with each other through core engine 175. Thus, when presenter 100 requests an on demand audio/video clip from media server 195, the request is processed by core engine 175, which receives the request through web server 155. Then, after required authentications using database 165, core engine 175 sends the request to media server 195, which streams the requested clip to presenter computer 100 and participant computers 120 where the resident media players render the streamed clip. Turning to live audio streaming, once the streaming media connection is established, the presenter and participants are free to collaborate audibly. The general process for the streaming audio collaboration is controlled by audio/video application 170 in conjunction with core engine 175 as depicted in FIG. 16. At broadcasting computer 1410, voice input is received 1600 from a microphone (not shown) and is being encoded by encoder 1605. Then, the audio stream is transmitted to media engine 1400 (contained within audio video application 170), which pushes that stream to the user who sends the request (listening.jsp) for it using http/IP tunneling. The audio stream is then transmitted to recipient computer 1420 where the audio stream is optionally sampled 1615 for quality control of the audio signal, sent through a decompression algorithm 1620 performed by the codec, and then output 1625 to the listener on a speaker or other sound generation means (not shown). The streaming audio collaboration process depicted in FIG. 16 is described below in more detail.

More specifically, the system utilizes the following detailed processes for transmitting streaming live audio from broadcasting computer 1410 (i.e., the computer of a user that is speaking which may be presenter computer 100 or participant computers 120):

1. Server 140 under control of media engine 1400 activates the Microsoft Windows Media Encoder on broadcasting computer 1410.

2. The voice is captured from the sound card's microphone input (default audio device) of broadcasting computer 1410.

3. The voice/video is changed into data and vise versa by Marshing techniques.

4. The data (voice) stream is converted into Advance Streaming Format (ASF).

5. The data (voice) is then compressed to reduce its size of data (voice) with the help of Windows Media Audio Codec.

6. The compressed stream is then transmitted from broadcasting computer 1410 on port 80.

The system then utilizes the following process for receiving the streaming live audio at recipient computer 1420:

1. The Windows Media Player control is invoked by server 140 under control of media engine 1400 embedded in a Java Server Page (JSP) to recipient computer 1420 along with IP tunnel initiation.

2. When the particular JSP is activated at recipient computer 1420, an IP tunnel is automatically created with broadcasting computer 1410, which is transmitting the audio stream on port 80.

3. When the IP tunnel is successfully created the embedded player in recipient computer 1420 starts rendering the audio.

4. The buffer for the audio stream is first filled and then played.

The particular JSP is fully automated and automatically will create a new IP tunnel if the previous IP tunnel collapses or breaks-up due to any network issue in the Internet cloud between broadcasting computer 1410 and recipient computer 1420 (i.e., the computer transmitting the stream and the computer receiving the stream).

System Architecture

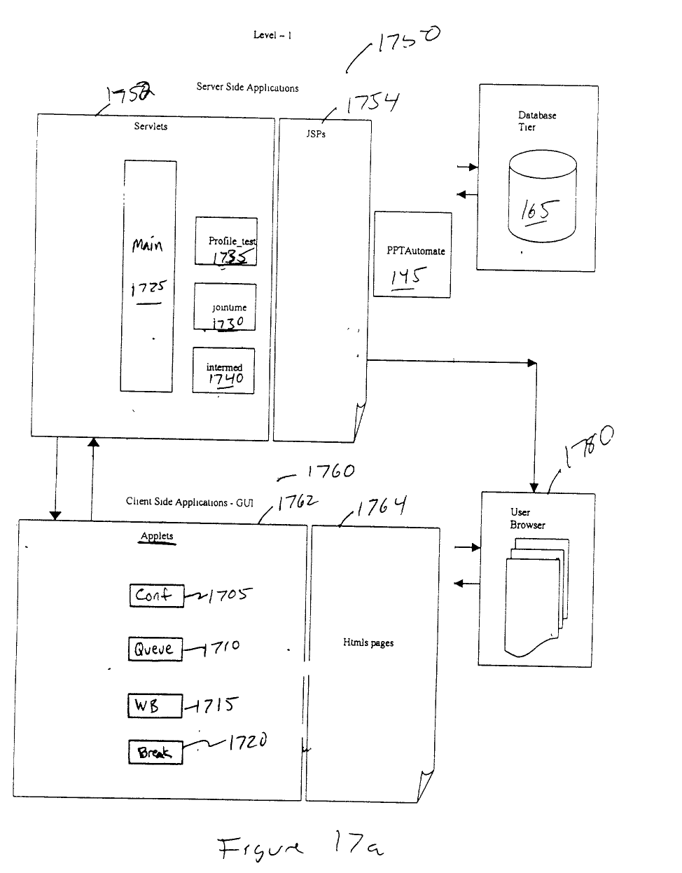

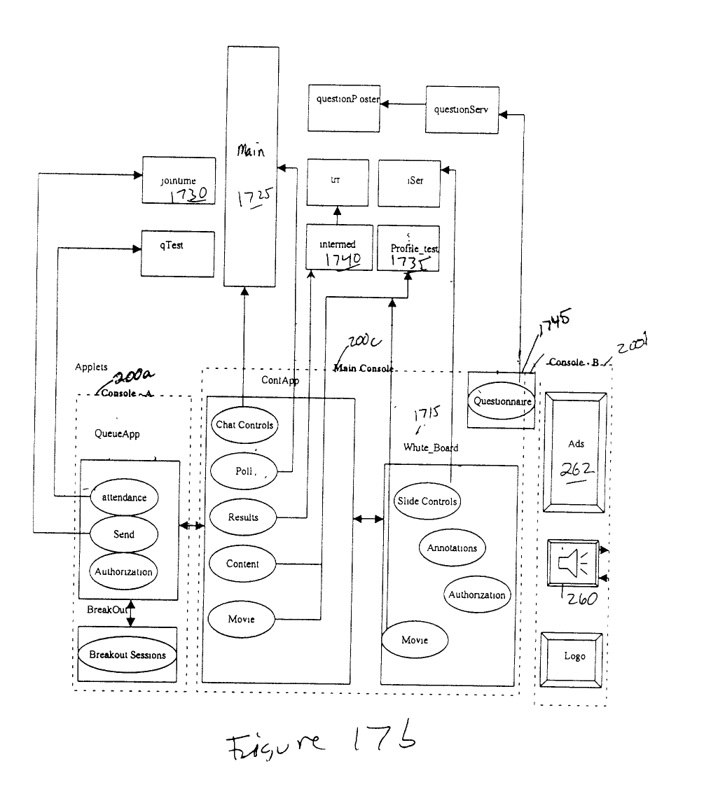

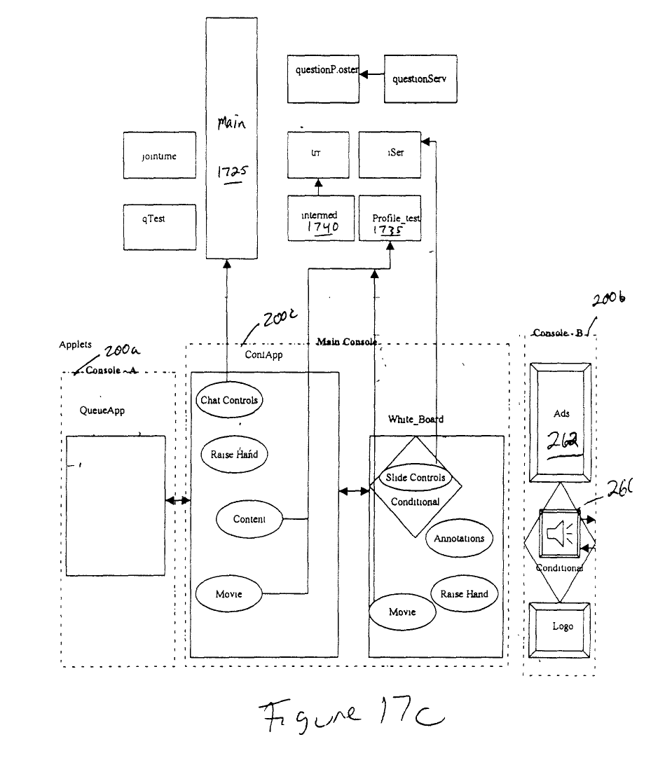

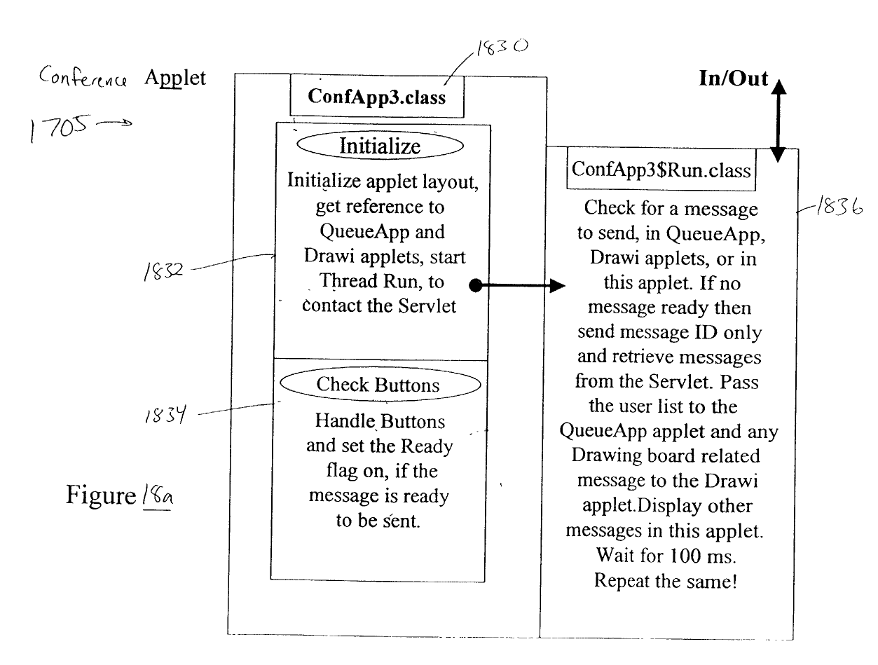

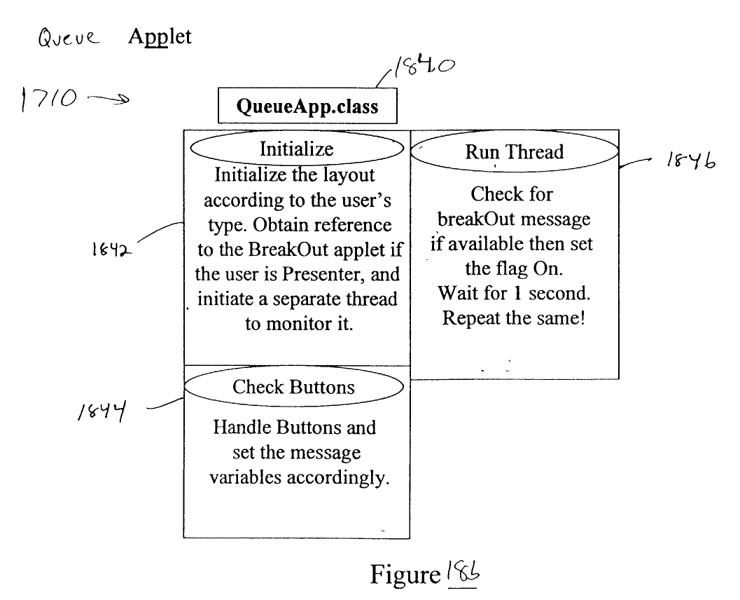

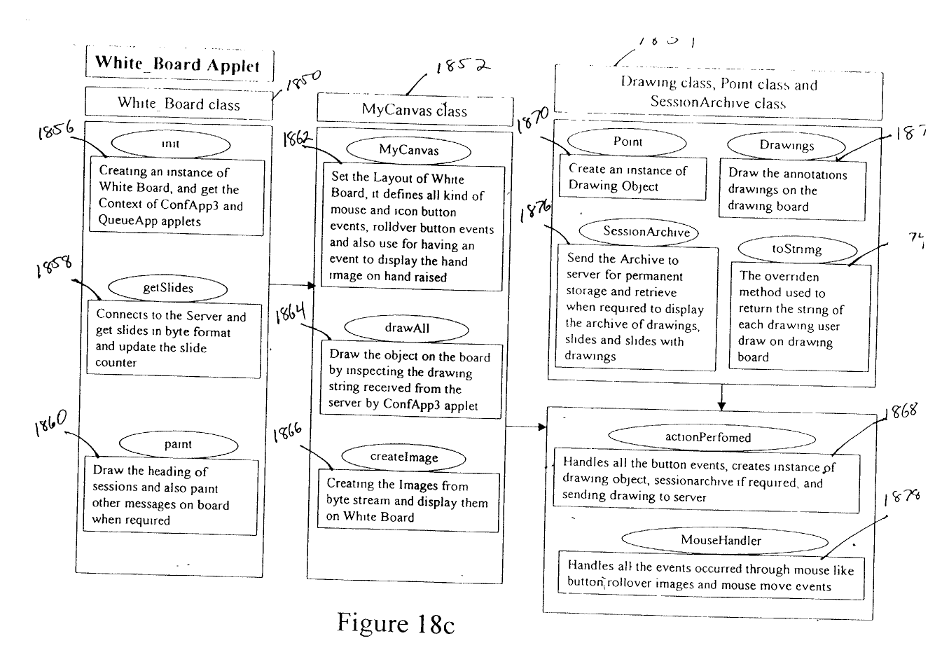

The system architecture is based upon the use of Java Applets, Java Servlets, and Java Server Pages (JSP) which provide the real time and highly functional interactive capabilities such as audio and video streaming allowing both the presenters and users the ability to introduce and react to visual and audio data instantaneously. A Java applet is a program executed from within another application. Applets and servlets are divided into classes, and within each class are data objects comprising fields (i.e., variables) and methods. Fields tell what an object is, and methods tell what an object does. Each class, which is the abstraction of an object, is developed to perform certain activities (i.e., one or more methods for carrying out a task). FIGS. 18a-d and 19, which describe the main applets and servlets of the preferred embodiment, depict the key activities provided by the major classes and inner classes.

Unlike an application, applets cannot be executed directly from the operating system. With the growing popularity of OLE (object linking and embedding), applets are becoming more prevalent. A well-designed applet can be invoked from many different applications.

Web browsers, which are often equipped with Java virtual machines, can interpret applets locally from web servers. Because applets are small in file size, cross-platform compatible, and highly secure (can't be used to access users' hard drives if not signed), they are ideal for small Internet applications accessible from a browser and are very popular for development of thin client applications.

User Interface Architecture

Referring now to FIG. 17a, the overall system layout is shown detailing the relationship between server 140 side applications 1750 (comprising servlets 1752, JSP's 1754 and conversion engine 145), client 100/120 side applications 1760 (comprising applets 1762 and HTML pages 1764), and client side browsers 1780. Servlets 1752 of web server 155 control the push of applets 1762 to web browser 1780 of presenter computer 100 and participant computers 120, as well as the access to database 165. The client side applications 1769 facilitate the display of and user interaction with the graphical user interfaces depicted in FIGS. 2-7.

Web browser applets 1762 pushed by web server 155 include four major applets: conference (ConfApp3) applet 1705; queue (QueueApp) applet 1710; whiteboard (White_Board) applet 1715, and breakout applet 1720. Conference applet 1705 is the main applet and its primary purpose is to provide conferencing functions. The primary purpose of queue applet 1710 is to provide threaded queue functions. Whiteboard applet 1715 is primarily responsible for drawing functions. Breakout applet 1720 is primarily responsible for breakout of a session into as many groups as desired.

As depicted in FIGS. 17b and 17c, applets 1762 are organized with respect to the client's web browser environment (see the graphical user interfaces depicted in FIGS. 2-7). In particular, queue applet 1710 and breakout applet 1720 control the functions of control A console 200a, and conference applet 1705 and whiteboard applet 1715 control the functions of master communication console 200c. Each applet 1762 is responsible for certain functions on the graphical user interface. Queue applet 1710 controls the attendance, send, and authorization functions; breakout applet 1720 controls the breakout session function; conference applet controls the chat, polling, poll results, content, and audio/video clip and streaming functions; whiteboard applet 1715 controls the access to whiteboard 400 from main communication console 200c as well as the slide controls, authorization, annotation, and audio/video clip and streaming functions on whiteboard 400. Questionnaire applet 1745 controls the dynamic questionnaire function for the session.

Web server 155 is constructed of several servlet applications 1762. The major servlets include main 1725, jointime 1730, profile_test 1735 and intermed 1740. The main servlet 1725 is primarily responsible for session initialization, user list refreshing, message writing and user disconnection activities carried out by web server 155. These applets 1762, servlets 1752, as well as JSP's 1754 serve to facilitate the system functionality described in the User Interface, Advertisements, Automated PPT Conversion and Media Streaming Sections above. Jointime 1730, profile_test 1735 and intermed 1740 servlets receive commands generated from various applets 1762.

HTML pages 1764 provide the viewable portion of the graphical interface on web browser 1780 such as the presentation of ads 1762. In comparison, applets 1762 provide control functions for the graphical user interface on web browser 1780. JSP's 1754 provide many server operations to enable the graphical user interface to publish dynamic contents, for example, calculating details of questionnaire results, listing archived sessions, and many more supporting utilities.

FIG. 17b depicts the client side web browser environment for the graphical user interface on a presenter computer 100, while FIG. 17c depicts the client side web browser environment for the graphical user interface on a participant computer 120. When compared, participant computer 120 does not receive breakout applet 1720, since participants do not have the ability to initiate break out sessions. Additionally, participant computers 120 only have conditional presentation slide control, i.e., only when authorized by the presenter. The same conditional control applies to microphone selector 260 on participant computers 120.

Conference Applet 1705

Referring now to FIG. 18a, shown is a block diagram detailing the major activities of conference applet 1705 broken down by class. Conference applet 1705 is comprised of the following principle classes: ConfApp3 class 1830 and ConfApp3$Run class 1836. Other classes are provided for creating the logout dialog window, showing the dialog window and creating a canvas (20×20 pixels) for hand raising icon 485. The principle classes and their respective activities are discussed below.

ConfApp3.Class 1830

ConfApp3 class 1830 is the main applet class. It creates a separate thread (for each session) to communicate with the server. The class includes an initialize activity 1832, which initializes the applet layout, retrieves references to queue 1710 and whiteboard 1715 applets and starts the thread run activity to contact main servlet 1725. Check button activity 1834 handles the buttons and sets the ready flag on if a user message is ready to be sent.

Other activities (not shown in FIG. 18a) provided by ConfApp3 class 1832 include laying out the components (text boxes and buttons) on the screen, checking whether the user is a presenter or a participant, obtaining the reference of other applets (i.e., queue applet 1710 and whiteboard applet 1715) in the page, obtaining a reference to the other applets in case reference could not be obtained during initialization, handling the button clicking events, mouse events, prefixing messages according to the button pressed (i.e., it sets the message prefix to “Ans:” or “Que:”, if the button pressed has the label “Answer” or “Question”), displaying an error message if a button is pressed but no text has been typed in the text box and the button requires some textual message, alerts, informing server 140 that the user has left so that the attendance be updated and other users in the session informed and assigning a different color to every new participant who whispers.

ConfApp3$Run Class 1836

ConfApp3$Run class 1836 is an inner class, which executes in a separate thread and communicates with main servlet 1725. It checks queue applet 1710, whiteboard applet 1715, and the instant applet for messages to send. If no messages are ready, then the applet sends only a message ID and retrieves messages from main servlet 1725. It also passes the user list (i.e., the names in audience list box 202) to queue applet 1710 and any drawing board related messages to whiteboard applet 1715 and displays other messages in conference applet 1705. These functions are repeated every 100 milliseconds (in real time).

Other activities provided by ConfApp3$Run class 1836 (not shown on FIG. 18a) include displaying the user names in audience list box 202, informing the users about any newcomers or departing users, parsing the whisper message string and displaying it on the message bar in the color associated with the whisperer, and displaying messages in appropriate text boxes or opening up whiteboard 400 depending on the message type.

Queue Applet 1710

Referring now to FIG. 18b, shown is a block diagram detailing the major activities of queue applet 1710 broken down by class. The primary class of queue applet 1710 is Queueapp class 1840, which has three key activities: initialize 1842, check buttons and mouse events 1844, and run thread 1846. Additionally, the activities of this class maintain the users, hand-raisers, and whispering user lists. Apart from those lists, the activities in the class provide controls to authorize and unauthorize the participants as well as opening files and websites to the participants.

Initialize activity 1842 lays out the users and hand raisers' lists and check the user type (i.e., presenter, participant or specialist). If the user is a presenter applet 1710 presents other controls like authorize buttons, unauthorize buttons, file and web-site opening text boxes and buttons as well as break out session buttons. In case of a participant, queue applet 1710 displays the users and hand-raisers lists only. Run thread activity 1846 creates a new thread to check the break out session in case a presenter creates one. Check buttons activity 1844 monitors the button selections and sets the message variables accordingly.

Queue applet 1710 keeps the reference of breakout applet 1720 and conference applet 1705 keeps the reference of queue applet 1710. This inter-applet communication is facilitated by variables whose values are shared by the applets.

An inner class of QueueApp class 1840 (not shown in FIG. 18b) provides the activities for creating the popup dialog box for polling, which is called from conference applet 1705 when the presenter presses poll button 246, laying out the polling dialog box with buttons and a text box, responding to the buttons and depending on the button pressed makes the dialog box invisible.

Queue applet 1710 utilizes a number of key variables, which are monitored by conference applet 1705 thread to send messages to web server 155 which in response pushes applets to presenter computer 100 and participant computers 120. By way of example, the presenter may authorize a participant to ask a question. A request is sent from presenter computer 100 via Internet 130 to server 140, which processes the request and generates an applet, which is transmitted to presenter computer 100 and participant computers 120.

Whiteboard Applet 1715

Referring now to FIG. 18c, shown is a block diagram detailing the major activities of whiteboard applet 1715 broken down by class. Whiteboard applet 1715 includes the following classes:

White_Board.Class 1850

White_Board class 1850 is the main class and includes several key activities: initialize 1856 to create the instance of whiteboard 400 and get the context of conference applet 1705 and queue applet 1710, getslides 1858 to get the slides from server 140 according to the session presentation information, and paint 1860 to draw the heading information surrounded by a box on the top of whiteboard 400. Important activities of White_Board class 1850 (not shown in FIG. 18c) include setting the size of the applet and opening a URL connection with server 140.

MyCanvas Class 1852

MyCanvas class 1852 provides several activities including mycanvas 1862 for laying out whiteboard 400, drawall 1864 for drawing annotations, and createimage 1866 for creating and displaying images form the byte stream (i.e., image stream), actionperformed 1868 for handling all button events (i.e., selections by the user), and mousehandler 1878 for handling all mouse events such as tracking the mouse's start and end points and mouse movements when the presenter or authorized use draws on whiteboard 400.

Additionally, inner classes of MyCanvas class 1852 (not shown in FIG. 18c) provide many activities such as closing of the text dialog, displaying alerts, displaying a text box, displaying hand icon 485 on presenter whiteboard 400a when participant presses raise-hand button 480, displaying the rollover buttons and annotation buttons, calling the tooltip class to display the tool tips when the mouse moves over the annotation buttons, performing the navigation action of slides for the next and previous rollover buttons, adding the insets (borders) in the layout of whiteboard 400 to set its look and feel, and overriding the paint method for displaying the panels in light gray colors. ToolTip class is an external class used for displaying the tool tips on annotation (icon) buttons to make them more meaningful.

Point, Drawing, SessionArchive Classes 1854

Point class is a simple utility class used to represent any point (represented by an x-position and y-position) on whiteboard 400 and return the points for annotations. Drawing class is used to display the annotations on whiteboard 400. SessionArchive class is used to fetch the slide archives from server 140 and stream the archive string to server 140 to be stored in encoded format.

These classes provide a number of activities including: point 1870 to create an instance of an annotation, drawings 1872 to draw the annotations, toString 1874 to return variables for each annotation, and sessionarchive 1876 to send and receive archives of annotations with slides (complete presentation archiving) to server 140 for later use.

BreakOut Applet 1720

Referring now to FIG. 18d, shown is a block diagram detailing the major activities of breakout applet 1720 broken down by class. This applet is comprised of the following primary classes: BreakOut class 1880 and BreakOut$BreakFrame$DialogWin class 1882. BreakOut class 1880 is an entry point to the session breakout dialog window and one of its inner classes creates the session break out dialog window. The class provides initialize activity 1884 to create instances of the breakout dialog window.

BreakOut$BreakFrame$DialogWin class 1882 is the main class which actually controls the session breakout management. Initialize activity 1886 lays out the breakout management dialog window. An audience list activity initializes the audience list of the session and holds the names in a vector for future use in the session.

ActionPerformed activity 1888 handles the buttons and takes appropriate actions. If the “Create” button is selected, a new breakout session is created from the available audience list. If the “Switch User” button is selected, participants are switched from one breakout session to another and the list of sessions is displayed by calling fillchoices activity 1892. In this case, if any session becomes empty (i.e., no participants) it is no longer listed. If the “OK” button is selected, Handletask activity 1890 is called to carry out the task (based on the task (button) selected first). If the “cancel” button is pressed, the initiated task is cancelled and the starting screen is displayed.

Handletask 1890 is called actionPerformed 1888 upon selection of the “OK” button, which carries out the task according to the task (button) selection and updates the breakOutString variable being monitored by queue applet 1710 and changes the layout of the dialog to the starting screen.

ItemStateChanged activity 1892 controls the lists (combo boxes) of breakout sessions and users in each list and calls activities to get the user lists and fillChoices 1892. FillChoices activity 1894 simply fills the lists (combo boxes) with available sessions and names in the main session and calls getListOfUsers method.

Main Servlet 1725

Referring now to FIG. 19, shown is a block diagram detailing the major activities of main servlet 1725 broken down by class. Main Servlet 1725 is comprised of the following primary classes: tSer class 1900; tSer$SessionMessages class 1905 and tSer$Polling class 1910. TSer class 1900 is the main servlet class which controls all the conferencing in text and drawings. The tSer$SessionMessages class 1910 objects control and hold the session messages. tSer$Polling class 1910 (via initialize activity 1960) creates the polling object for the different sessions. Breakout sessions are tracked with a session number passed as a parameter. Each break out session number is negative with the session id encoded in that number.

Tser class 1900 allows main servlet 1725 to initialize sessions 1915, refresh user lists 1930, write files 1935 and delete names of disconnected users activity 1940. Delete activity 1940 deletes the user name from the attendance list whose IP and session id is passed to it when the user's connection is lost or the user logs out of the session.

Upon initializing 1915, main servlet 1725 connects with database 165 and gets the list of users in the audience table. It also creates a thread to remove the users with a lost connection from the audience table.

The run thread activity 1925 checks the connection time of all users every 100 seconds and deletes the user name from the audience list who has not connected for 5 minutes and refreshes the audience list by calling delete activity 1940.

Once the connection is established, the audience list is refreshed by refresh list activity 1930 and write file activity 1935 is called to write the messages to the appropriate files, for the session id passed as a parameter, depending on the info type passed (question, answer or comments) for archiving the messages.

Service activity 1920 checks the audience list for illegal entries, records connection times of users, updates the polling table with the polling info passed to it for the particular session, and provides other service oriented functions. In more detail, service activity 1920 performs the following tasks in a stepwise manner:

1. It finds the connecting users IP address.

2. It refreshes the attendance list if the last refreshing has elapsed 10 seconds.

3. It checks the user in the attendance list.

4. If the user is not found in the list, it sends the message of “re-logging” or “wait” to the user.

5. If the user is found in the attendance list, it performs the following tasks and checks:

a. Finds the presenter of the user's session and adds it to the send message string.

b. Finds the session number of the user.

c. Reads the incoming message and takes appropriate action.

d. If the message starts with “Slide” it call the activity to get slide information and returns the presentation slides info to the user.

e. Finds the session information and adds it to the send message string.

f. Finds the users in the session of the connecting user and adds it to the send message string.

g. Checks the whisper message for the connecting user and adds it to the send message if any.

h. Finds the client's message number from its message.

i. Checks the connecting user's session messages, if he/she is lagging behind by at least two messages then creates a whisper message for the presenter of the same session if available. Updates the connecting user's connection time for later reference.

j. If the connecting user's message starts with “Left”, it calls delete activity 1940 to delete his/her name from the attendance list. It also updates the session messages of this user's session by removing any invalid messages that identify that the user has raised the hand or that the user is authorized. It also sends the user a “Bye” message.

k. If the connecting user's message starts with “Poll”, it creates a “Polling” object for this session if not available. It updates polling info into the same object and the database.

l. If the connecting user's message starts with “Hum” (whisper message), it updates whisper messages for the user to whom this message is targeted. It also adds NoDataHeader to the send message string.

m. If the message starts with “Mes:” means the user has not sent any message but only message id (number). User's message id is compared with the message number of the session messages object for the same session. If the user is lagging behind then all the messages are retrieved for this user and message id is changed to the new number. Otherwise, NoDataHeader is attached to the send message string.

n. If the connecting user's message starts with “Break”, it calls the breakout session method to change the attendance table. It also attaches the NoDataHeader to the send message string.

o. If the message starts with “Auth”, then the name of the authorized user is found from the attendance list. This message is modified and IP of the authorized user is attached to it. The session messages object, for the connecting user's session is updated with this new message. If the message starts with “Pre:”, “Que:” or “Ans:”, write file activity 1935 is called for archiving of this message.

p. Finally, the messages are retrieved from the session messages object and attached to the send message string.

6. The send message is sent to the connecting user.

Other activities of tSer class 1900 are provided to interrupt the thread and close the database connection when main servlet 1725 is unloaded and retrieve the presentation slides info from web published folder 1210.

Some important variables used in tSer class 1900 include attendanceTime variable which holds the time of the last attendance refresh; whispers variable used to hold the whisper messages of the users; allPolls variable which holds the Polling information of the session; sessionsinfo variable which holds the session info for the each on going session; connectionTime variable which holds the last connection time of the users; sessMessages variable which holds the session messages objects of the on going sessions; and Attendees variable which holds the list of users in the attendance list.

The activities of tSer$SessionMessages class 1905 include retrieve messages activity 1645 which compares the lastMessage ID of the connecting user and retrieves all unsent (maximum 5) messages from the session messages object, add message activity 1950 which adds the new message from the user to the collection of messages of this session, get message count activity (not shown) which returns the last message number of the session in question, and refresh messages activity 1955 which is called when the user leaves the session so that any message related to him or her can be deleted.

The activities of tSer$Polling class 1910 include holding the poll message; holding the count of “yes”, “no”, and “unsure” responses; and holding the count of polled questions in the session.

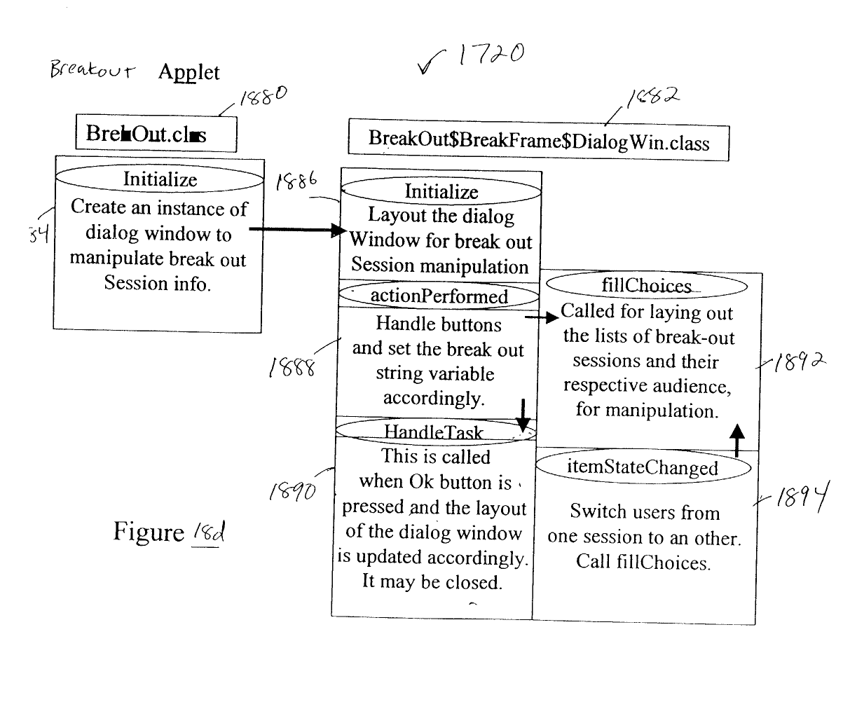

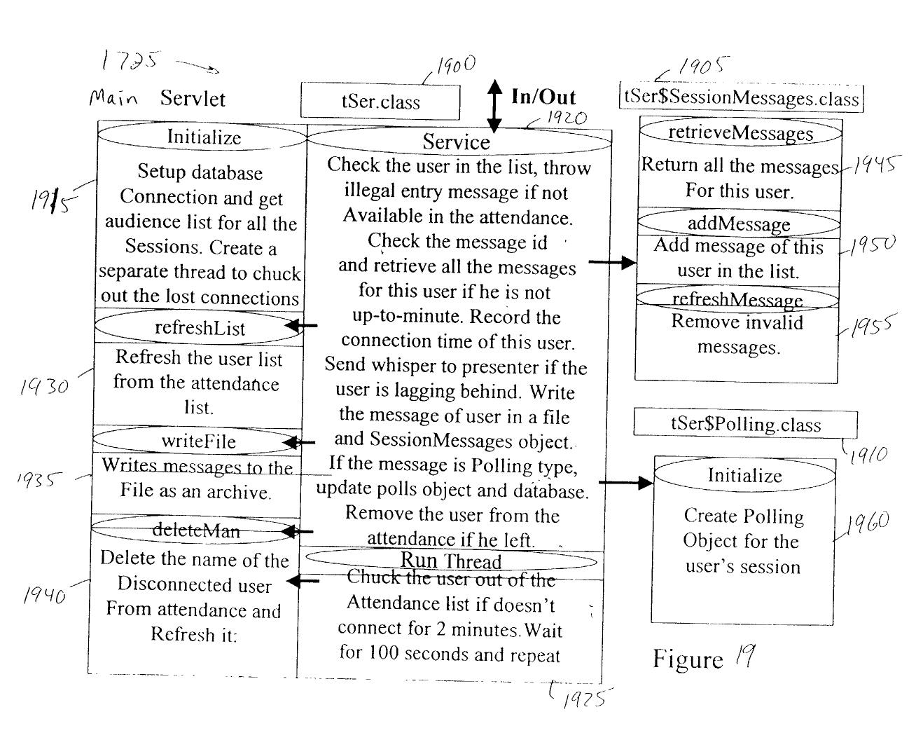

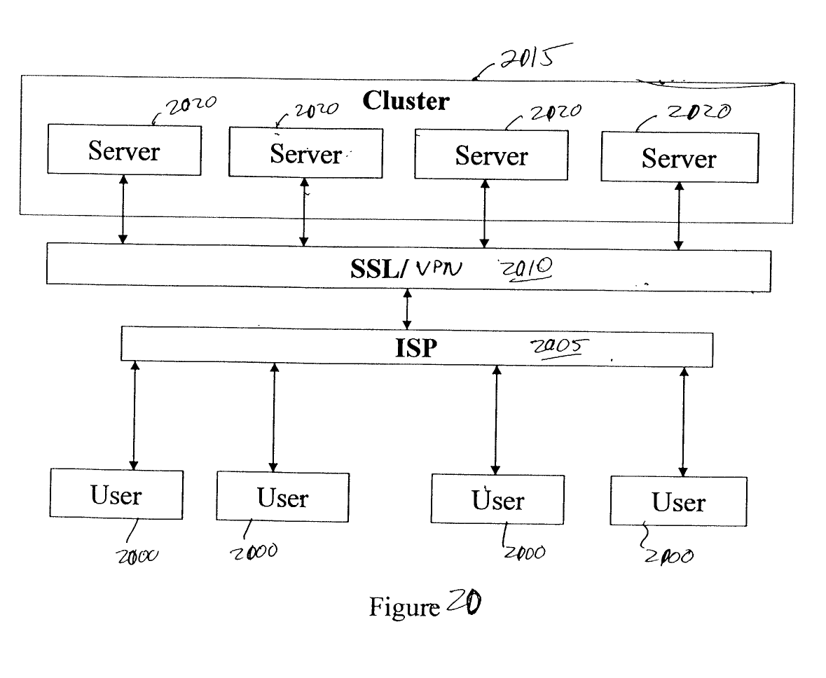

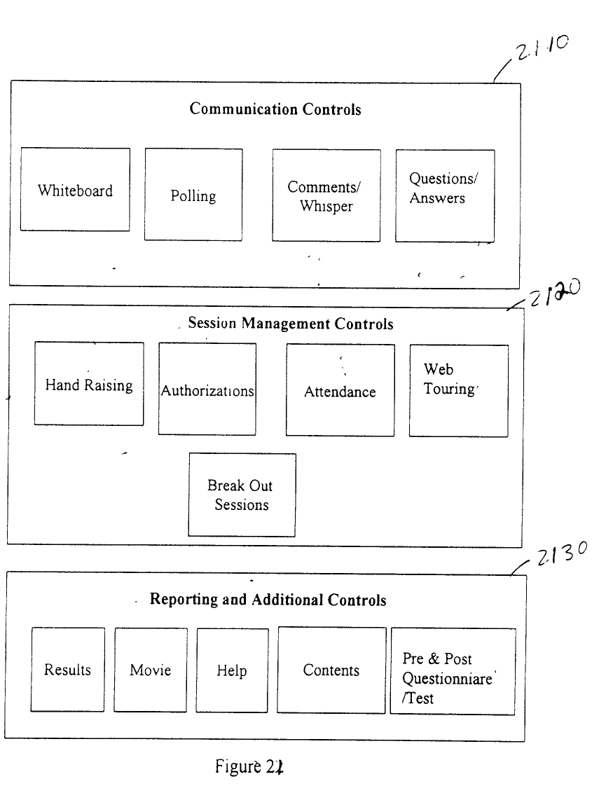

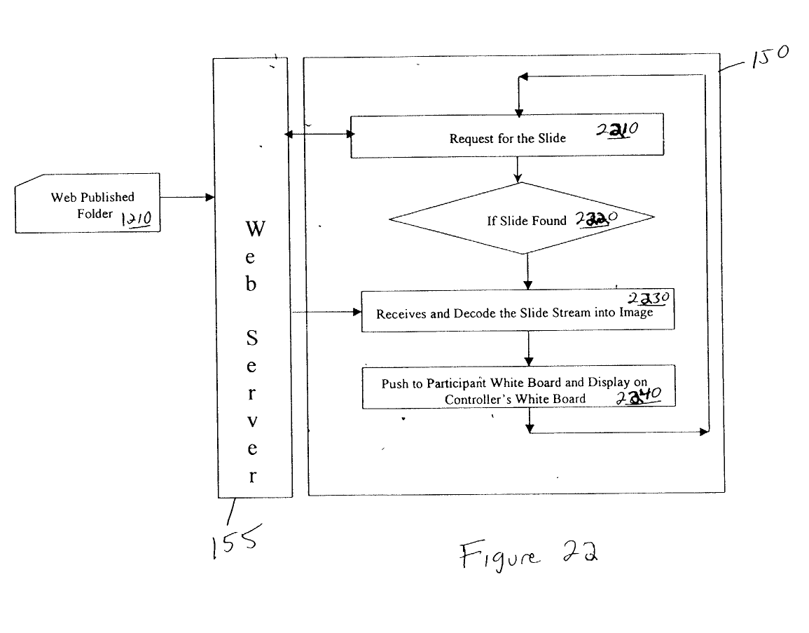

Referring now to FIG. 20, shown is a block implementation diagram detailing multiple user connections in a load-sharing environment. Users 2000 (i.e., presenter computer 100, specialist computer 180 and participant computers 120) are connected to SSL/VPN (Secure Socket Layer/Virtual Private Network) 2010 through an Internet service provider (ISP) 2005. Server Cluster 2015 is a collection of individual servers 2020, can be clustered to share the load of number of sessions running at the same times (i.e., multiple server tiers 140), which carry out the various functions of the system.

Much of the system architecture is built upon Java servlets, Java applets, JSP, HTML and Java script for controlling the system. FIG. 21 depicts the construction of various application controls of the system, which are divided into communication controls 2110, session management control 2120, and reporting and additional controls 2130. The sub-components under each category correspond to the various functions provided to the user though the graphical user interfaces depicted in FIGS. 2-7 and facilitated by the system architecture as depicted in FIGS. 17-19.

Whiteboard Architecture

Turning to the remaining figures. FIG. 22 is a block diagram detailing whiteboard application 150 of the system architecture. As shown, a request 2210 is made for a particular slide show (in the form of a slide stream) from a particular presentation via core engine 175 (whiteboard applet 1715 on the client side communicates with main servlet 1725 on the server side) to web published folder 1210 in web server 155. Whiteboard application 150 then determines if the slide was found 2220. If the slide stream is found, the requested slide stream is received and decoded 2220 by whiteboard application 150 into an image stream, which avoids caching by participant computers 120 and prevents participants from saving or accessing the presentation at the end of the session. This helps ensure the confidentiality and protect the presentation from unregulated dissemination. Whiteboard application 150 then pushes 2240 the slide image to participant computers 120 for display on whiteboard 400.

In summary, the whiteboard presentation process is carried out by whiteboard applet 1715, which sends the request to server 140 for a particular slide. Server 140 takes that request and searches for it in web published folder 1210. Once found, server 140 converts the image into an image stream and sends that stream to the session presenter and all connected session participants. Then whiteboard application 150 (locally runs on each machine as whiteboard applet 1715) converts the image stream back into an image and displays it on whiteboard 400. The cycle then repeats for each slide as the presenter proceeds through the slide show presentation. To enhance performance, once a slide is decoded and loaded into virtual memory (but not cached), the next request for that same slide (e.g., the presenter back tracks in the presentation) reads the slide from memory not from web published folder 1210.

The foregoing discussion discloses and describes merely exemplary methods and embodiments of the present invention. One skilled in the art will readily recognize from such discussion that various changes, modifications and variations may be made therein without departing from the spirit and scope of the invention. Accordingly, disclosure of the present invention is intended to be illustrative, but not limiting, of the scope of the invention, which is set forth in the following claims and their legal equivalents.

I claim:

1. A method for converting an application specific presentation file stored in a first data store with corresponding metadata to a universal format for display on a web browser, comprising the steps of:
reading the metadata corresponding to the application specific file from the database;
determining from the metadata whether the file extension corresponds to the specific application;
loading the application specific file from the database;
validating that the application specific file corresponds to the specific application by examining header information of the application specific file;
converting the application specific file into a universal image file format;
modifying the resolution of the universal format file;
validating the resolution of the universal format file; and
storing the modified universal format file in a second data store for display on the web browser.

2. The method recited in claim 1 further comprising the steps of:
uploading the application specific file to the first data store; and
detecting the uploaded application specific file in the database.

3. The method recited in claim 1 further comprising the step of:
transmitting the modified universal format file to the web browser for display.

4. The method recited in claim 1, wherein the universal image file format is a JPEG format.

5. The method recited in claim 1, wherein the modifying step modifies the resolution of the universal format file to 400×300.

6. The method recited in claim 1, further comprising the steps of:
converting the modified universal format file to an image stream; and
transmitting the image stream to the web browser for display.

7. A method for converting a PowerPoint formatted presentation file stored in a first data store with corresponding metadata to a universal format for display on a web browser, comprising the steps of:
uploading the PowerPoint file to the database;
detecting the uploaded PowerPoint file in the database;
reading the metadata corresponding to the PowerPoint file from the database;
determining from the metadata whether the file extension corresponds to the specific application;
loading the PowerPoint file from the database;
validating that the PowerPoint file corresponds to the specific application by examining header information of the PowerPoint file;
dispatching the PowerPoint file to a converter algorithm application;
converting the PowerPoint file into a universal image file format;
modifying the resolution of the universal format file;
validating the resolution of the universal format file;
storing the modified universal format file in a second data store; and transmitting the modified universal format file to the web browser for display.

8. The method recited in claim 7 further comprising the steps of:
uploading the application specific file to the first data store; and
detecting the uploaded application specific file in the database.

9. The method recited in claim 7 further comprising the step of:
transmitting the modified universal format file to the web browser for display.

10. The method recited in claim 7, wherein the universal image file format is a JPEG format.

11. The method recited in claim 7, wherein the modifying step modifies the resolution of the universal file format to 400 by 300 pixels.

13. The method recited in claim 7, further comprising the steps of:
converting the modified universal format file to an image stream; and
transmitting the image stream to the web browser for display.

14. A system for converting an application specific file presentation files stored in a first data store with corresponding metadata to a universal format for display on a web browser, comprising the steps of:
means for reading the metadata corresponding to the application specific file from the database;
means for determining from the metadata whether the file extension corresponds to the specific application;
means for loading the application specific file from the database;
means for validating that the application specific file corresponds to the specific application by examining header information of the application specific file;
means for converting the application specific file into a universal image file format;
means for modifying the resolution of the universal format file;
means for validating the resolution of the universal format file; and
a second data store, wherein the modified universal format file is stored in the second data store for display on the web browser.

15. The system recited in claim 13 further comprising:
means for uploading the application specific file to the first data store; and
means for detecting the uploaded application specific file in the database.

16. The system recited in claim 13 further comprising:
means for transmitting the modified universal format file to the web browser for display.

17. The system recited in claim 13, wherein the universal image file format is a JPEG format.

18. The system recited in claim 13, wherein the means for modifying modifies the resolution of the universal file format to 400 by 300 pixels.

19. The system recited in claim 13, further comprising:
means for converting the modified universal format file to an image stream; and
means for transmitting the image stream to the web browser for display.
